(19) United States
(12) Patent Application Publication
(10) Pub. No.: US 2024/0337569 A1
(43) Pub. Date: Oct. 10, 2024

(54) Apparatus for producing biologic microarray blocks, and method for manufacturing, and usage the same

(71) Applicant: ibrahim Abukhiran, pittsburgh, PA (US)

(72) Inventor: ibrahim Abukhiran, pittsburgh, PA (US)

(21) Appl. No.: 18/534,670

(22) Filed: Dec. 10, 2023

Related U.S. Application Data
(60) Provisional application No. 63/495,079, filed on Apr. 7, 2023.

(51) Int. Cl. G01N 1/36

(52) U.S. Cl. CPC G01N 1/36; G01N 2001/366; G01N 2001/368

(57) ABSTRACT

This application introduces a chambered mold for tissue microarray blocks construction, addressing significant challenges in conventional methods. The chambered mold comprises main chambers, each with open end, allowing for insertion of donor samples in various forms. The method involves identifying parent samples, extracting donor samples, inserting them into main chambers, and subsequently adding matrix material. The chambered mold, serving as a casting system, holds the donor samples, cassette, and matrix material together, facilitating a uniform embedding process. The partially embedded microarray block is then subjected to completion embedding using a specialized mold or a fenestrated solid paraffin bar. This system's advantages include uniform tissue levels, ease of insertion, elimination of melting requirements, reusability, versatility in sample types, flexibility in donor tissue size, suitability for limited quantity tissues, absence of a recipient block, no disposable components, and avoidance of hot surface flattening, marking a transformative advancement in microarray construction.

### CROSS-REFERENCE TO RELATED APPLICATIONS

This application claims priority to U.S. provisional patent application Ser. No. 63/495,079 filed Apr. 7, 2023, the entire content of which is incorporated herein by this reference.

### PRIOR ART

JP2004258017A 2004 Sep. 16 Array block preparation method, tissue scooping-out device used for the same, and tissue block
JP2006162489A 2006 Jun. 22 Manufacturing method of tissue microarray, and production kit thereof
JP4083119B2 2008 Apr. 30 Method and apparatus for preparing and providing tissue samples for histological studies
CN101300471A 2008 Nov. 5 Method and apparatus for handling tissue samples
JP4373438B2 2009 Nov. 25 Recipient block and manufacturing method thereof
JP2010185673A2010-08-26 Tissue microarray preparation method
US20100323907A1 2010 Dec. 23 Frozen cell and tissue microarrays
US20110046017A1 2011 Feb. 24 Mold of recipient block and usage thereof
CN102042922B 2012 Jul. 4 Method for making once-forming tissue chip and mold applied to same
U.S. Pat. No. 8,349,584B2 2013 Jan. 8 Microarrays and their manufacture
CN103060175B 2014 Jul. 2 Cell micro-array chip and preparation method thereof
WO2015069742A1 2015 May 14 Tissue array for cell spheroids and methods of use
U.S. Pat. No. 9,523,629B2 2016 Dec. 20 Method for producing tissue microarray blocks of cell cultures
Liang et al. 2017 3D-printed high-density droplet array chip for miniaturized protein crystallization screening under vapor diffusion mode
KR101860502B1 2018 May 23 Pillar assembly and preparing apparatus for sample block comprising the same
CN109312300B 2023 Jan. 10 Spherical tissue microarray and preparation method thereof
U.S. Pat. No. 11,300,486B1 2022 Apr. 12 Apparatus for producing high yield cores for use in a microarray block, method for using same
US20220074828A1 2022 Mar. 10 Device, system, and method for rapid fixation and embedding of biological specimens
EP3177905B1 2020 Sep. 23 Method for providing a tissue array using a carrier medium

### BACKGROUND OF THE INVENTION

The construction of biologic microarrays is a widely employed technique in histopathology, facilitating the concurrent analysis of numerous biologic samples on a single microscope slide. Microarrays find diverse applications, notably in biomarker discovery and disease diagnosis. Traditionally, tissue embedding involves the use of metal or plastic molds; however, the lack of orientation control in this method poses challenges in accurately analyzing distinct tissue samples. Consequently, the construction of microarrays entails combining multiple biologic samples from various sources into a matrix material block, allowing for the precision cutting of thin sections.

It is imperative to emphasize that biologic microarrays comprise samples from multiple specimens, potentially originating from different patients. Consequently, meticulous tracking of each sample in the array back to its original parent specimen becomes crucial. An orientation mechanism is employed to assign a numerical identifier to each sample in the array, ranging from 1 to a specified number. This numbering system correlates each number with a specific parent sample from an individual patient. Conventional microarray construction methods lacking an orientation mechanism prove suboptimal for researchers and pathologists.

Existing methods for constructing biologic microarrays often involve inserting small tissue cores from various samples into cylindrical holes in a recipient block made of matrix material. Subsequently, this block is sectioned and analyzed on a single slide. While these techniques provide tissue orientation, they are characterized by being time-consuming, labor-intensive, and prone to a high rate of tissue loss. This is attributed to the variable distances at which the tissues are embedded from the cutting surface of the block, resulting from the diverse lengths of donor sample cores. To address these challenges, we have developed an apparatus for constructing biologic microarray blocks, ensuring uniform embedding of all donor samples at the same level and distance from the cutting surface. This innovation minimizes tissue loss and enhances efficiency, notably by eliminating the need for a recipient block, distinguishing it from existing methods.

### SUMMARY OF THE INVENTION

This patent application pertains to an apparatus used for the construction of biologic microarrays. The apparatus offers both manual and automated capabilities, suitable for use in automated microarrayers. In the accompanying figures, we illustrate an exemplary application of our invention. The process involves using a chambered mold to create a partially embedded microarray block (PEMB) from a series of donor samples. Subsequently, a completion mold is employed to produce a fully embedded microarray block (FEMB) that can be used for sectioning and analysis.

Compared to prior arts, our invention stands out in terms of efficiency and minimizing the risk of tissue loss. Additionally, our innovation includes an orientation mechanism that assigns a unique number to each sample in the microarray, thereby linking it to a specific parent sample. This feature facilitates precise analysis and interpretation of the samples.

The chambered mold consists of multiple main chambers designed to accommodate one or more donor samples. These main chambers possess two opposite ends, with at least one end being open. Typically, the chambers are cylindrical in shape, although they can also be of various other geometric configurations such as cubes, prisms, spheres, or parallelepipeds.

Our invention effectively addresses the issue of tissue loss associated with prior art, and it does so for two primary reasons. Firstly, our approach ensures that the samples are embedded at a consistent distance from the cutting surface of the block. Secondly, unlike prior art, our innovation eliminates the need for creation of a recipient block.

### BRIEF DESCRIPTION OF DRAWINGS

### Description of Reference Numerals (Ascending Order)

a. 6: Cassette to hold the microarray and the matrix material together
b. 7: Tissue punch.
c. 8: Donor sample
d. 9: Parent sample.
e. 10: Molten matrix material
f. 12: Core of solid matrix material holding donor sample that was inserted in the orientation chambers
g. 13: Parent block consisting of matrix material holding the parent sample.
h. 100: Chambered mold.
i. 101: frame.
j. 103: Cassette holder.
k. 104: Base.
I. 106: Reservoir.
m. 105: Orientation chamber.
n. 110: solid matrix material cuboid.
o. 120: cylindrical extensions of the matrix material in the partially-embedded-microarray block. These extensions serve to carry the donor samples microarray. The extensions are the inverse to the main chambers of the chambered mold.
p. 130: Final cuboid of solid matrix material without cylindrical extensions.
q. 200: Main chambers; from 201 to 215, where each main chamber is to receive a specific donor sample
r. 300: exemplary completion mold, where the partially-embedded-microarray block is inserted with its cylindrical extensions facing towards the completion mold
s. 301: Frame of completion mold
t. 303: Cassette holder of completion mold designed where the partially-embedded-microarray block is inserted into the completion mold with its cylindrical extensions facing down
u. 304: Base of completion mold designed where the partially-embedded-microarray block is inserted into the completion mold with its cylindrical extensions facing down
v. 400: exemplary completion mold, where the partially-embedded-microarray block is inserted with its cylindrical extensions facing away from the completion mold
w. 403: Cassette holder of completion mold designed where the partially-embedded-microarray block is inserted into the completion mold with its cylindrical extensions facing up
x. 500: exemplary chambered mold with movable parts
y. 503: Cassette holder of an exemplary chambered mold with movable parts
z. 504: Movable plurality of main chambers
aa. 800: Donor samples array.
bb. 801-815: individual donor samples
cc. 900: partially-embedded-microarray block
dd. 1000: Fully embedded microarray block.

### DESCRIPTION OF DRAWINGS

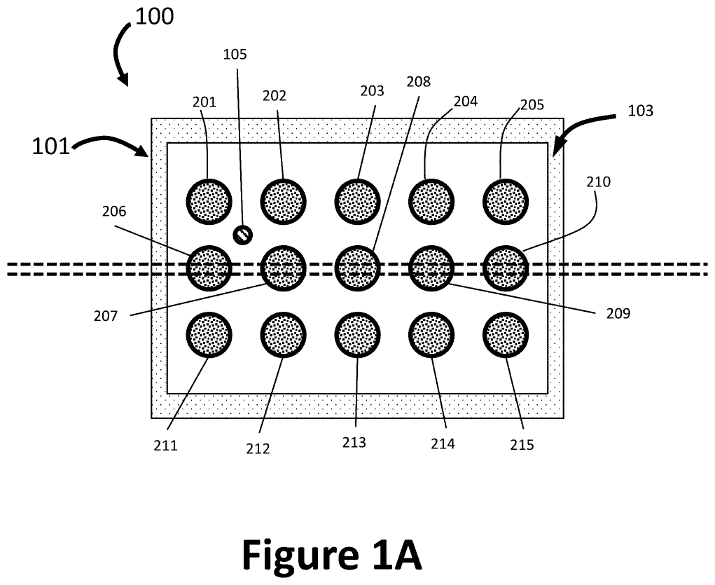

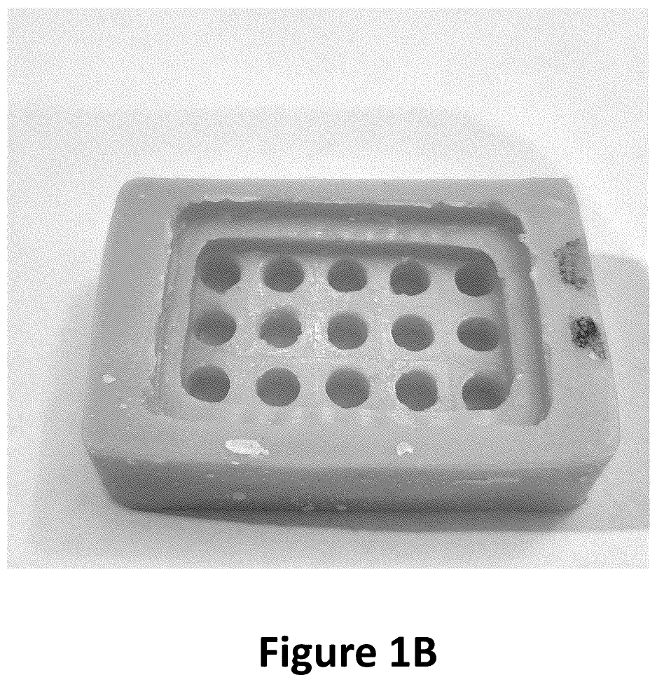

FIG. 1A illustrates a top view of the chambered mold (100), showcasing the main chambers (201-215). Optional components of the mold include a frame (101), a cassette holder (103), and an orientation chamber (105). Inside the mold, two dashed lines can be seen, acting as imaginary dividers that symmetrically divide the mold into two identical halves. These lines visually represent the plane from which the subsequent figures' cross-sectional views were captured.

FIG. 1B: A photograph of a prototype of a chambered mold designed to receive 15 donor samples (4 mm each).

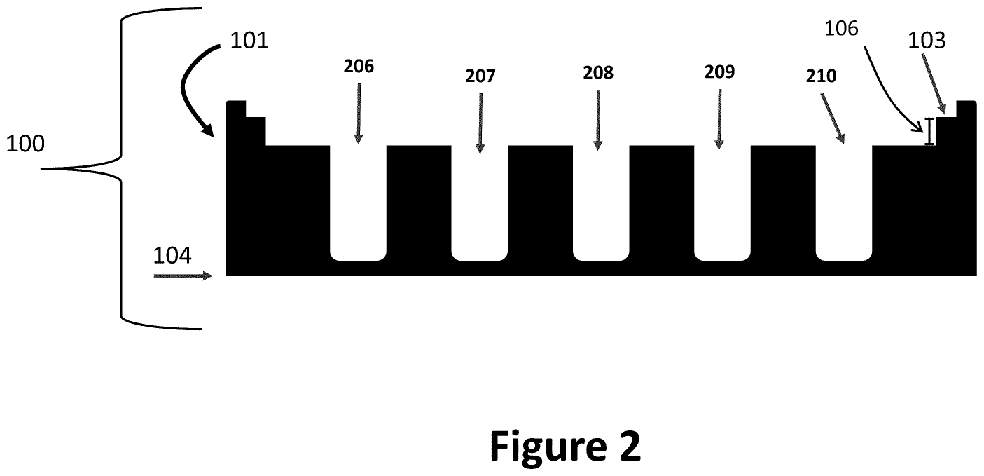

FIG. 2 illustrates a cross-sectional view of a chambered mold (100), specifically taken along the plane defined by the dashed lines in FIG. 1A). In this embodiment, the chambered mold has an optional frame (101), a cassette holder (103), base (104), and a reservoir (106).

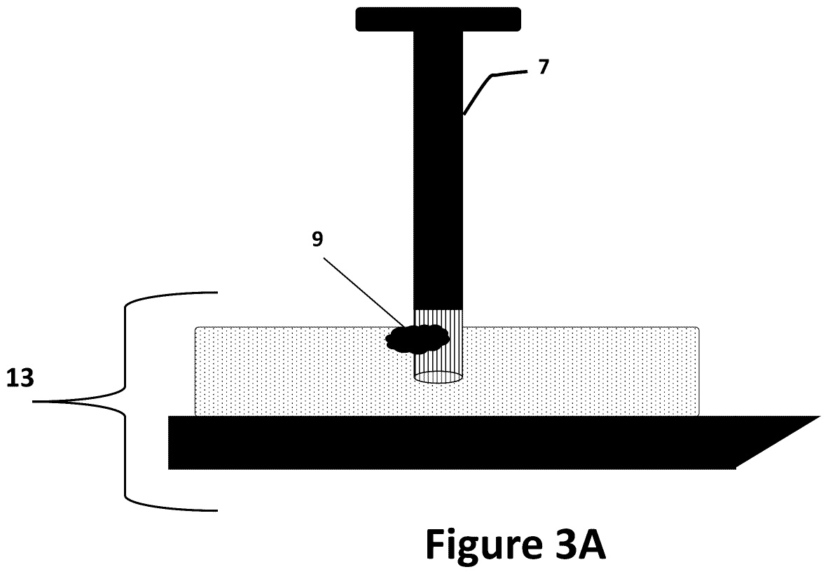

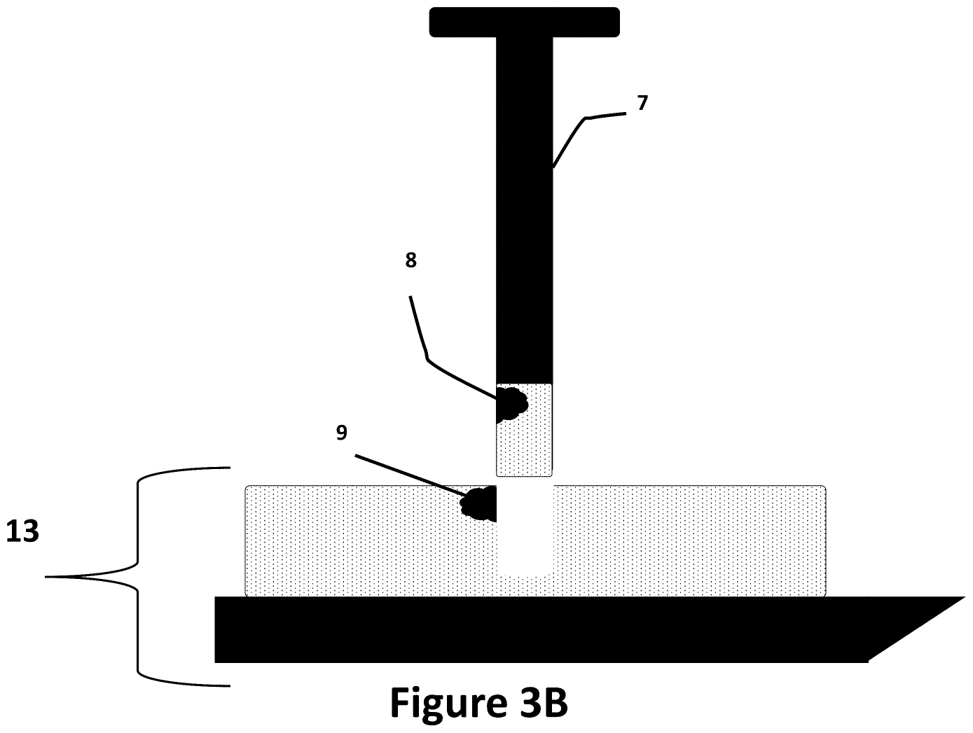

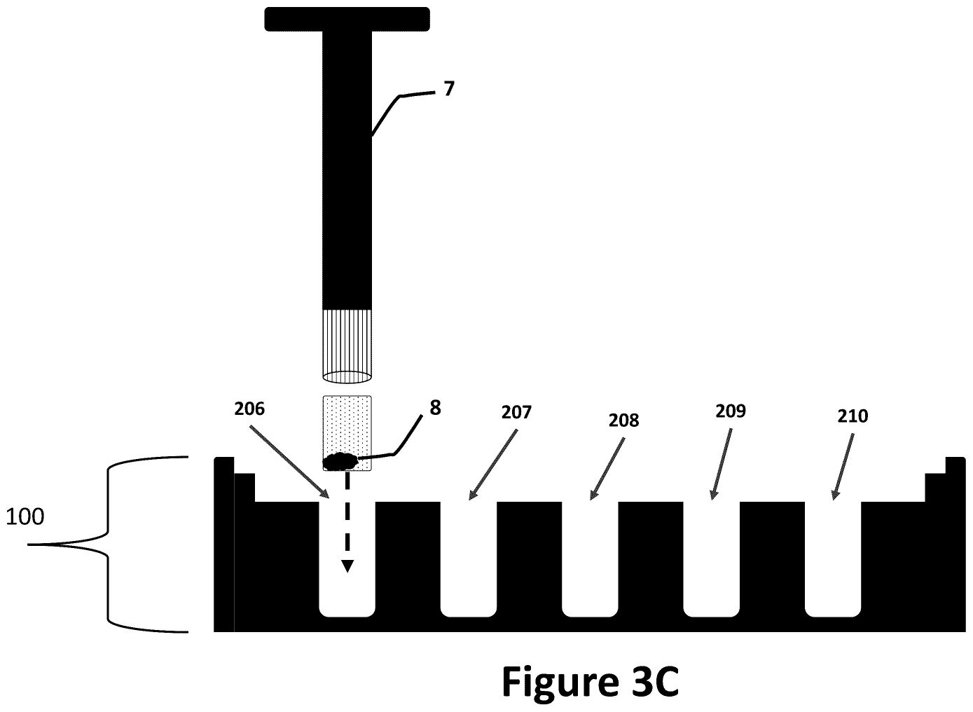

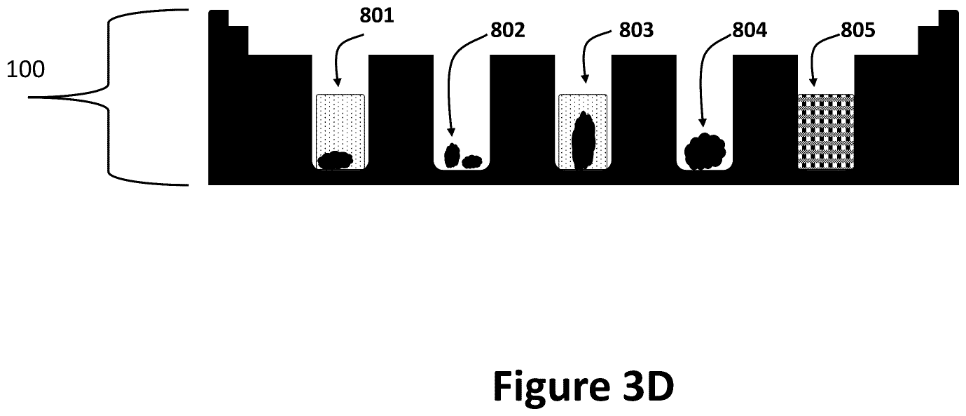

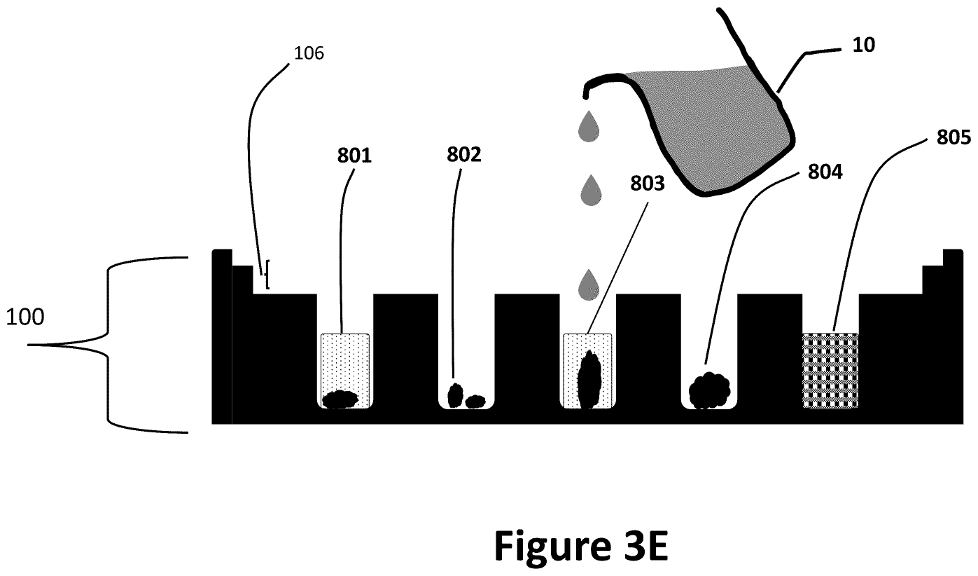

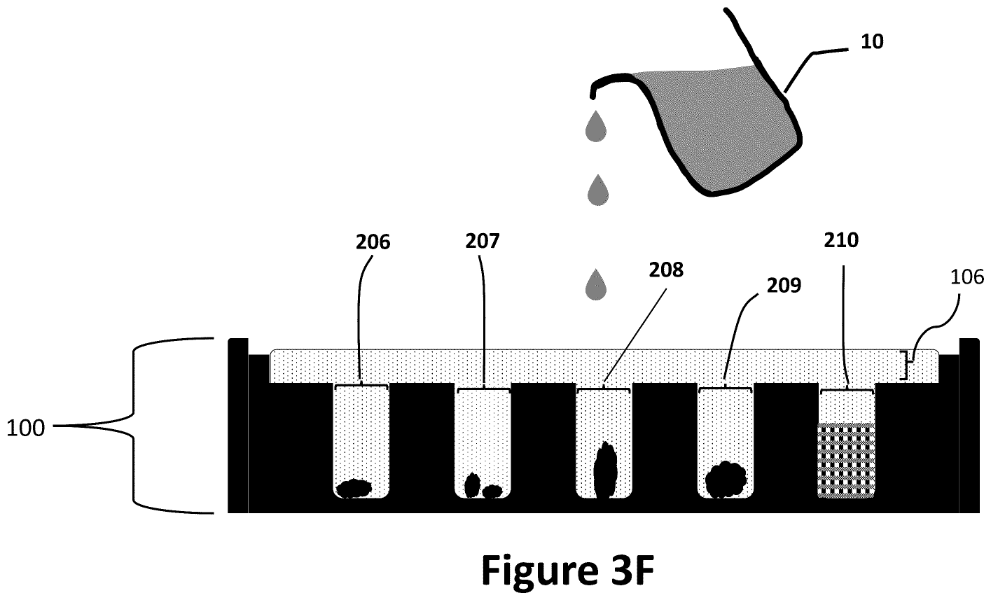

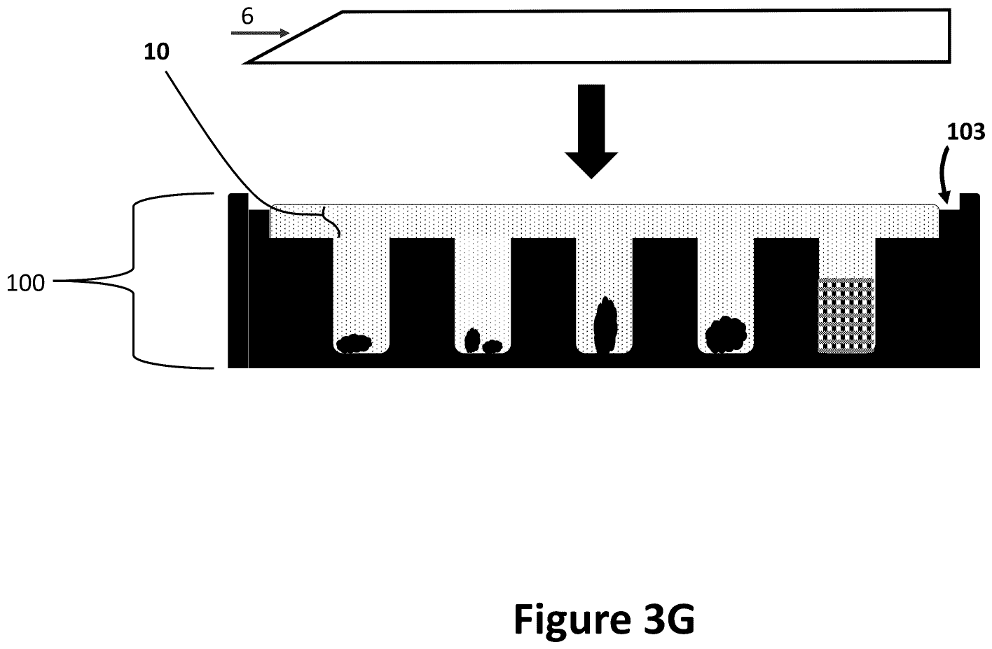

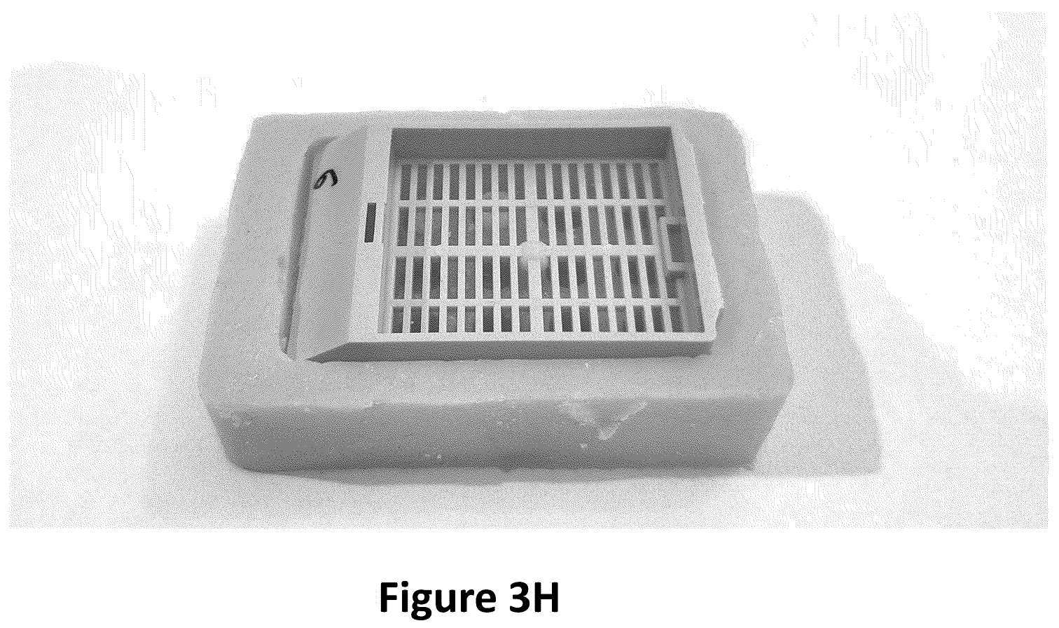

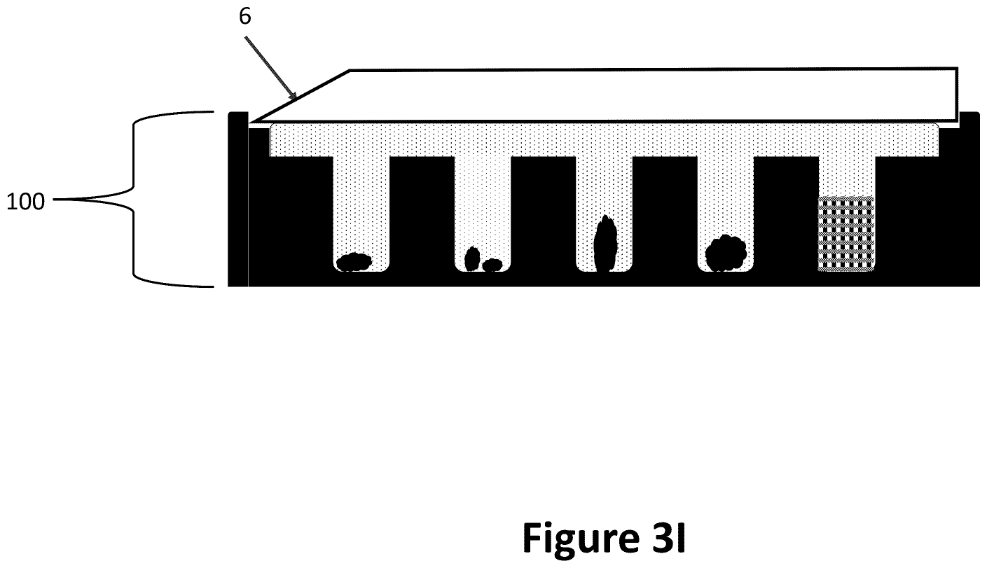

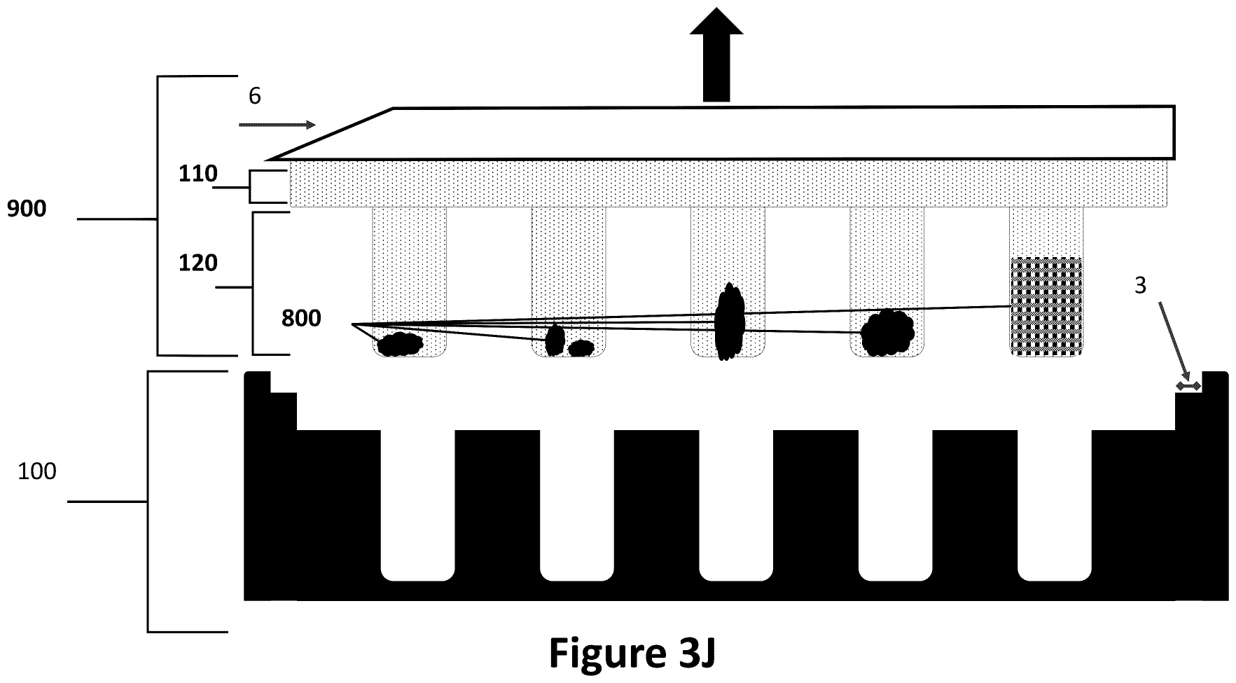

FIG. 3A showcases the usage of a tissue punch (7), which possesses a cylindrical bore. The purpose is to insert this instrument into the parent block (13) in order to extract a donor sample from the parent sample (9).

FIG. 3B: The tissue punch (7) is depicted being removed from the parent block (13). As a result, the donor sample (8) now resides within the cylindrical bore of the tissue punch. Meanwhile, the remaining parent sample (9) remains in the parent block.

FIG. 3C displays a cross-sectional view of the chambered mold (100), taken along the plane defined by the dashed lines in FIG. 1A. In this view, the donor sample (8) is shown being removed from the tissue punch (7) and subsequently inserted into one of the main chambers (206-210) within the chambered mold (100).

FIG. 3D presents a cross-sectional view of the chambered mold (100), taken along the plane defined by the dashed lines in FIG. 1A. In this view, multiple donor samples (801-805) are observed being inserted into the main chambers. Each known donor sample is deliberately placed in a specific chamber, ensuring the ability to trace them back to their respective parent samples. It is noteworthy that the donor samples may differ in size; for example, donor sample (803) is longer than the others, yet all are aligned on the same level. Additionally, some donor samples may consist of multiple fragments, like donor sample (802). Furthermore, certain donor samples can be inserted without being embedded in matrix material, as seen in donor samples (802) and (804). It is also worth observing that the donor samples can vary in composition, being either solid (e.g., donor samples 801 through 804) or liquid (e.g., 805), such as a liquid cytologic preparation of individual cells.

FIG. 3E Exhibits a cross-sectional view of the chambered mold (100), captured along the plane indicated by the dashed lines in FIG. 1). Once all the donor samples (801-805) have been inserted into their respective main chambers, the next step involves adding matrix material (10) to fill both the main chambers and the reservoir (106).

FIG. 3F Exhibits a cross-sectional view of the chambered mold (100), captured along the plane indicated by the dashed lines in FIG. 1A. In this embodiment, the chambered mold (100) is being filled with molten matrix material (10) to fill both the main chambers (206-210) and the reservoir (106).

FIG. 3G Displays a cross-sectional view of the chambered-mold (100), captured along the plane defined by the dashed lines in FIG. 1A. Once the matrix material (10) has been introduced, a cassette (6) is carefully placed inside the mold to provide physical support to the block. The cassette (6) is positioned on the cassette holder (103).

FIG. 3H: Photograph showing the plastic cassette inserted inside the prototype of the chambered mold

FIG. 3I Displays a cross-sectional view of the chambered-mold (100), captured along the plane defined by the dashed lines in FIG. 1A. After the cassette (6) is placed inside the mold, the matrix material is left to solidify.

FIG. 3J: Cross-sectional view of the chambered-mold (100). Cross-section taken along the plane of the dashed lines in FIG. 1A. In this embodiment, the partially embedded microarray block (900) is being removed from the chambered mold (100) after the matrix material has solidified. The partially embedded microarray block (900) consists of the cassette (6), the solidified matrix material cuboid (110), and the cylindrical extensions of matrix material (120) holding the donor samples array (800).

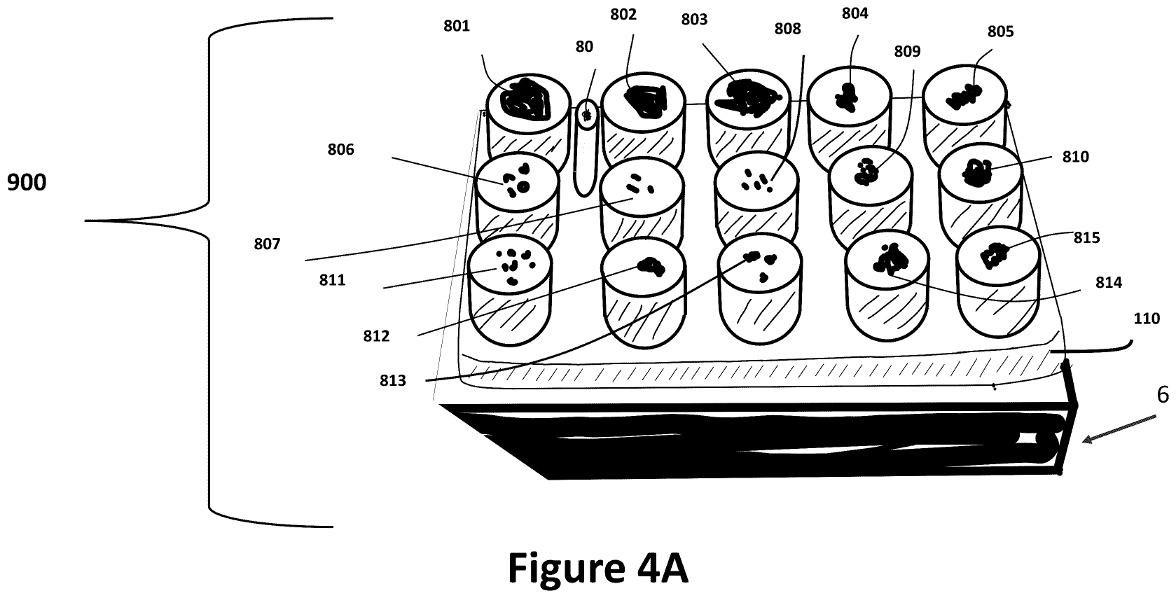

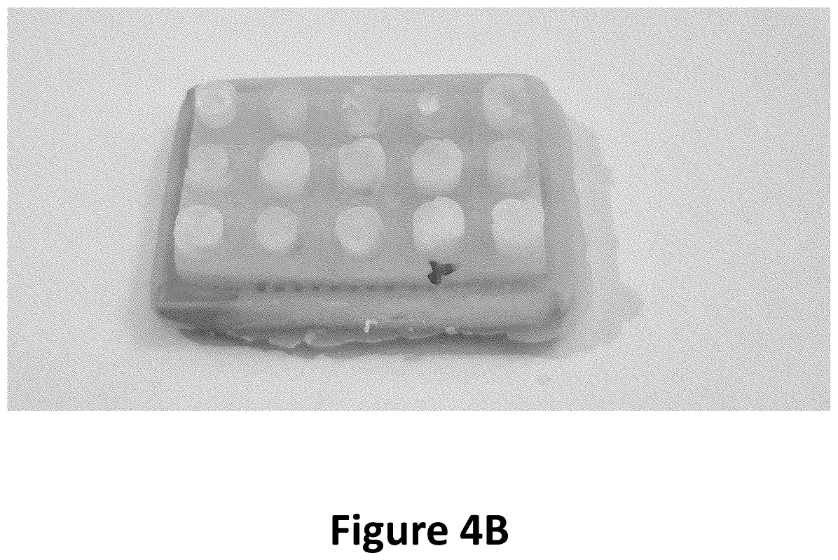

FIG. 4A: Perspective view of the partially embedded microarray block. The partially embedded microarray block (900) consists of the cassette (6), the solidified matrix material cuboid (110) with its cylindrical extensions holding the donor samples array (801-815). These multiple cylindrical extensions are the inverse to the main chambers of the chambered mold.

FIG. 4B: Photograph of a perspective view of the partially embedded microarray block. Notice how the matrix material is cuboid in shape with multiple cylindrical extensions that inverse to the main chambers of the chambered mold.

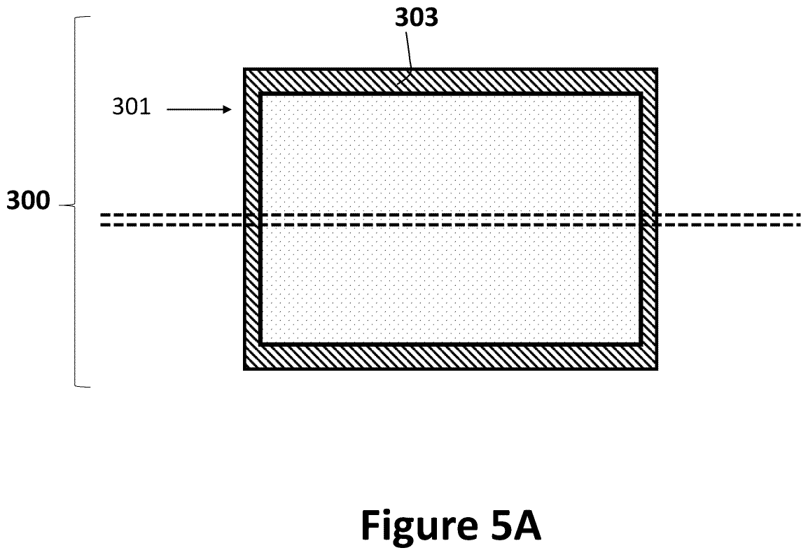

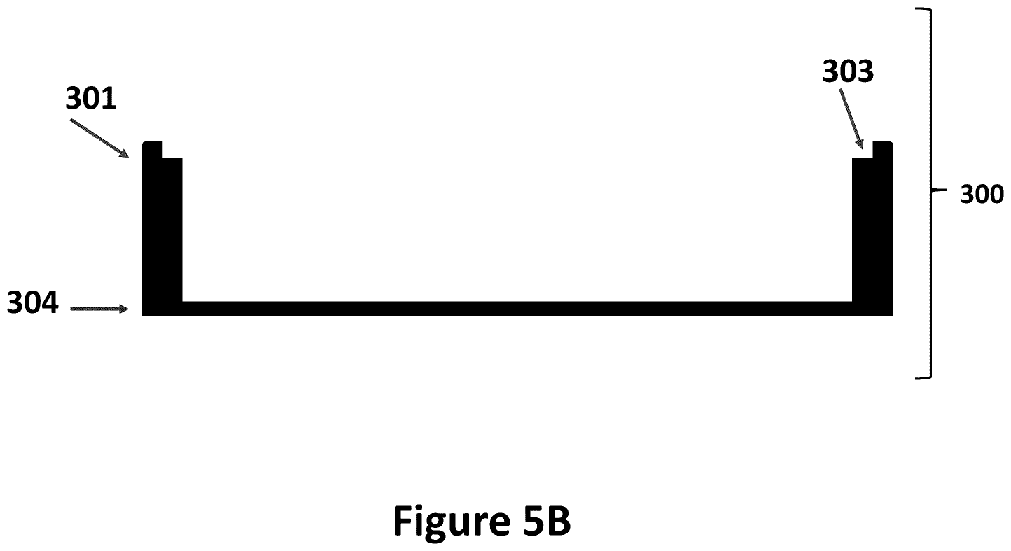

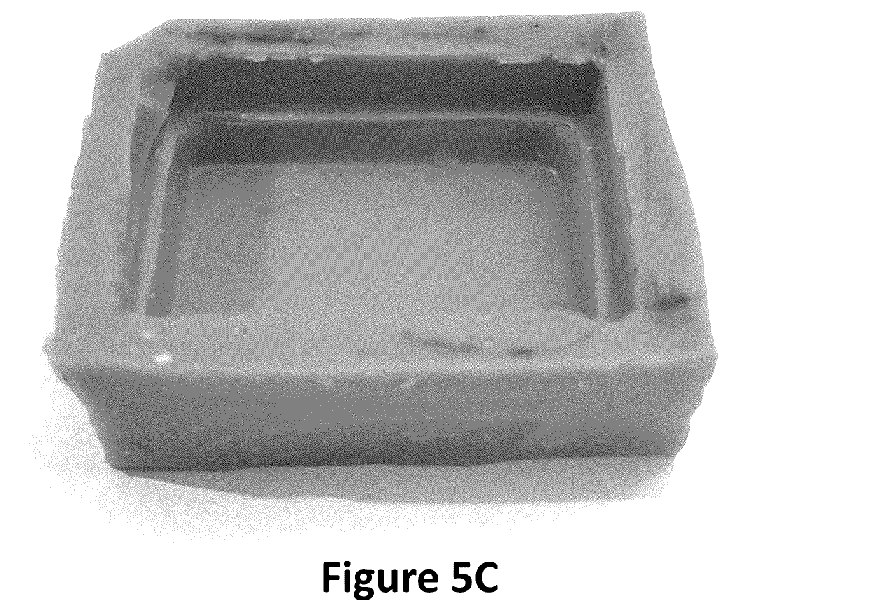

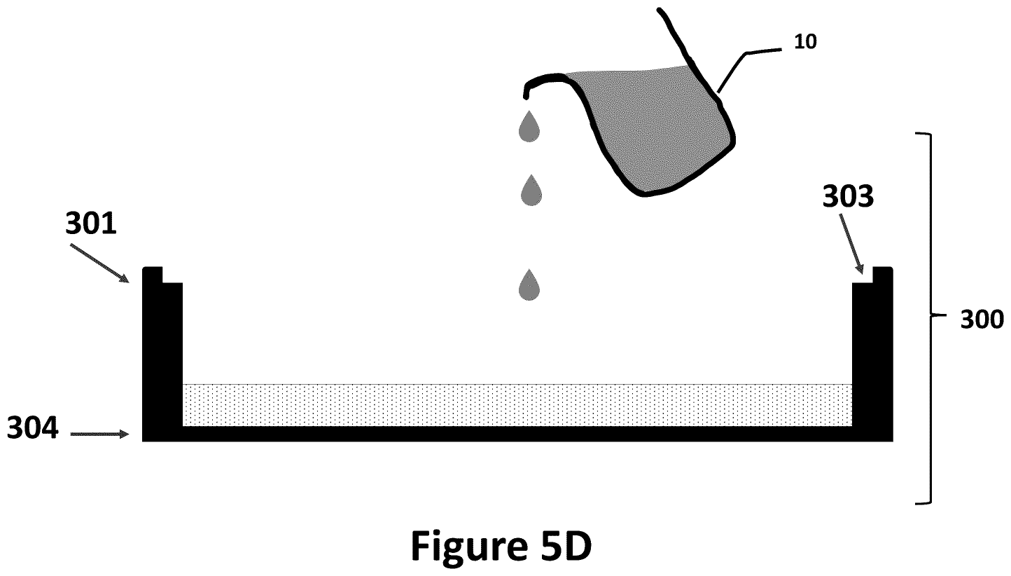

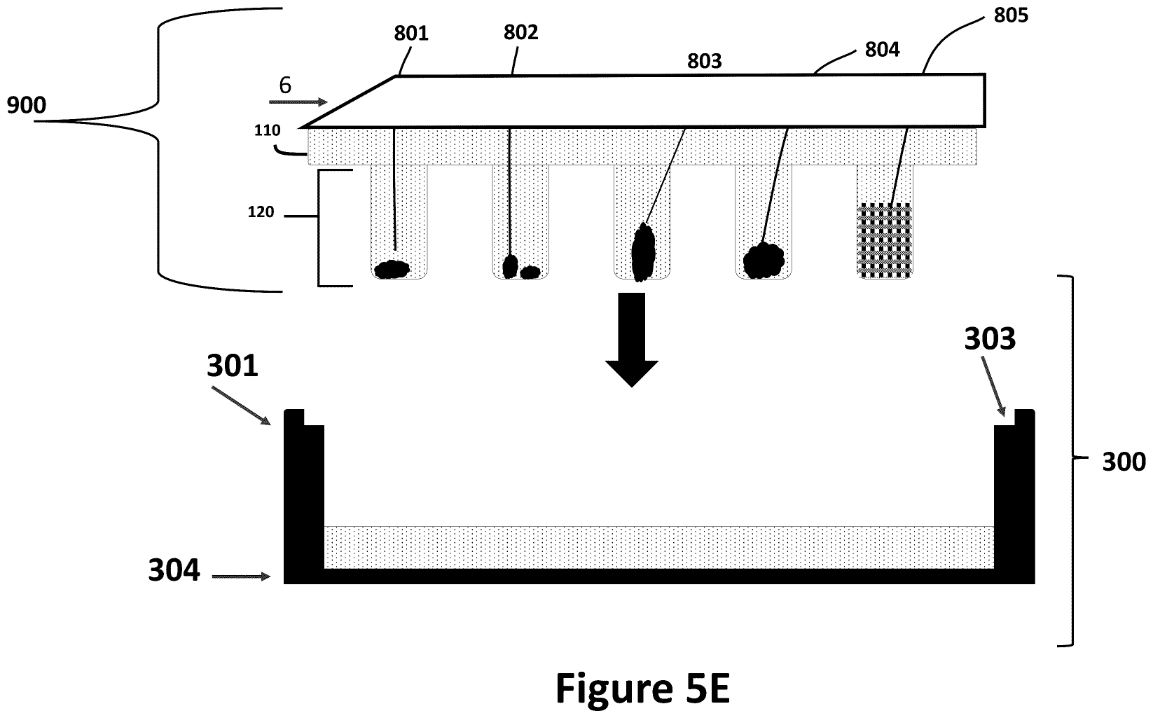

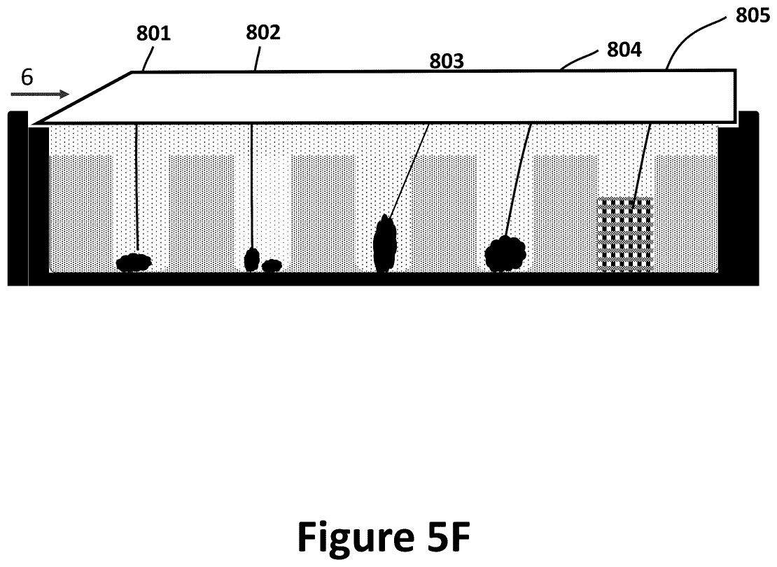

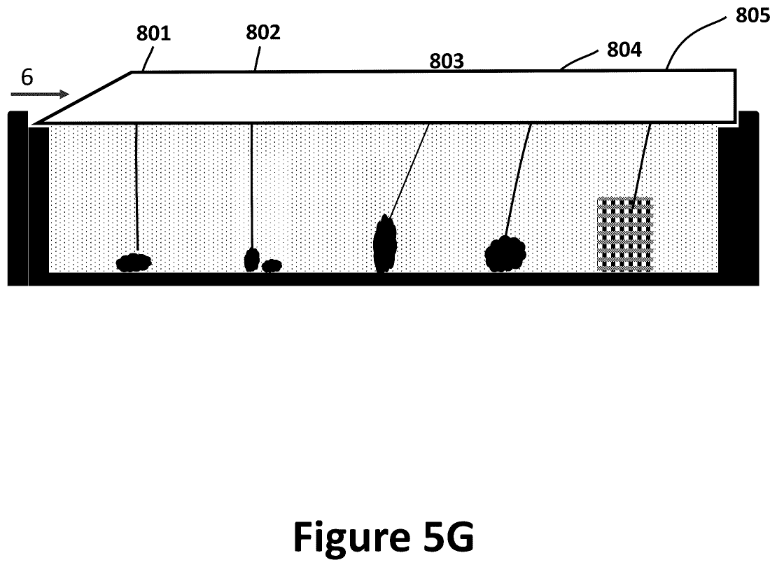

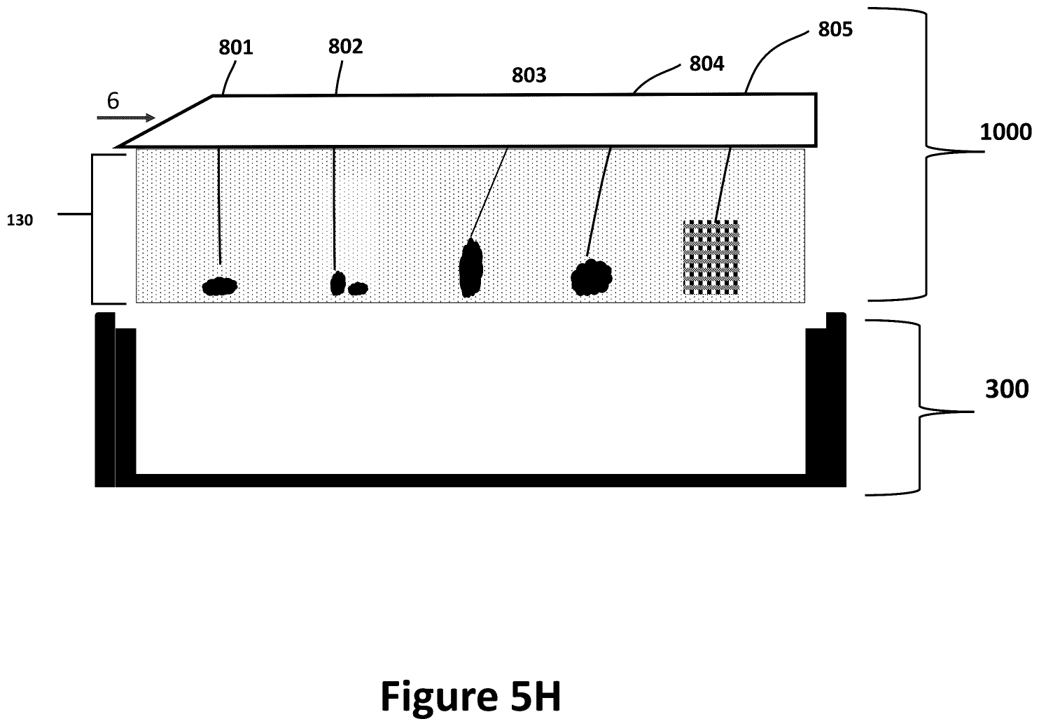

FIG. 5A, Top view of an example embodiment of a completion-mold (300). The two dashed lines are imaginary lines that separate the mold symmetrically to give two identical halves. These lines are to indicate the plane of which cross-sectional views were taken in subsequent figures. In this embodiment, the completion mold has a frame (301) and an optional cassette holder (303).

FIG. 5B, Cross-sectional view of an example embodiment of a completion-mold (300). Cross-section taken along the plane of the dashed lines in FIG. 5A. In this embodiment, the completion mold has a frame (301), base (304), and an optional cassette holder (303).

FIG. 5C: Photograph of a prototype of a completion mold designed to receive the partially embedded microarray block with its cylindrical extensions facing toward the completion mold.

FIG. 5D, Cross-sectional view of an example embodiment of a completion-mold (300). Cross-section taken along the plane of the dashed lines in FIG. 5A. In this embodiment, the completion mold has a frame (301), base (304), and an optional cassette holder (303). Matrix material (10) is added to the completion mold (300). The matrix material will serve to fill in the gaps in between the cylindrical extensions of the partially embedded microarray block.

FIG. 5E, Cross-sectional view of an example embodiment of a completion-mold (300) and the partially embedded microarray block (900). In this embodiment, the completion mold has a frame (301), base (304), and an optional cassette holder (303). In this embodiment, the partially embedded microarray block (900) is being inserted in the completion mold (300) containing some matrix material. The partially embedded microarray block (900) consists of the cassette (6), the solidified matrix material cuboid (110), and the cylindrical extensions (120) holding the donor samples array (801-805). Notice how in this example embodiment of the completion mold, the partially embedded microarray block (900) is inserted with its cylindrical extensions (120) facing toward the completion mold (300).

FIG. 5F, Cross-sectional view of an example embodiment of a completion-mold (300) and the partially embedded microarray block (900). The partially embedded microarray block (consisting of the cassette (6), the solidified matrix material, and the donor samples array (801-805)) is fully inserted in the completion mold (300). The matrix material is seen filling all the gaps in between the cylindrical extensions of the partially embedded microarray block.

FIG. 5G, Cross-sectional view of an example embodiment of a completion-mold (300) and the fully embedded microarray block (900). After all the matrix material has solidified, the microarray block is now fully embedded (consisting of the cassette (6), the solidified matrix material, and the donor samples array (801-805)).

FIG. 5H, Cross-sectional view of an example embodiment of a completion-mold (300) and a completely embedded microarray block (1000). In this embodiment, the fully embedded microarray block (1000) is being removed from the completion mold (300) after all the matrix material has solidified in the completion block (300). The fully embedded microarray block (1000) consists of the cassette (6) and donor samples array (801-805) fully embedded in a final cuboid of solid matrix material (130).

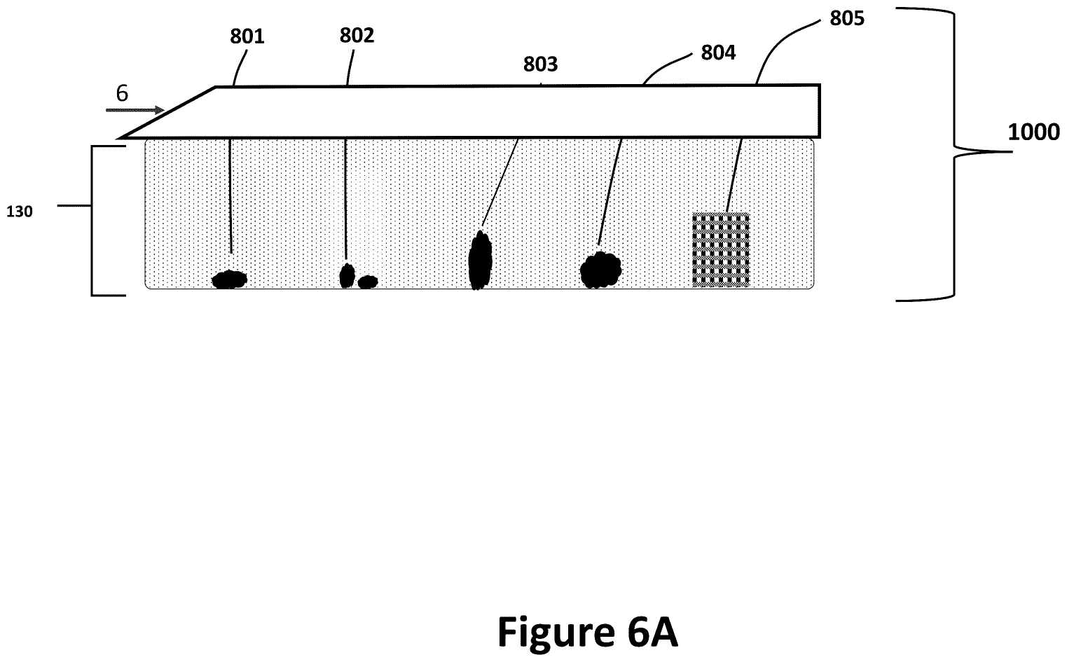

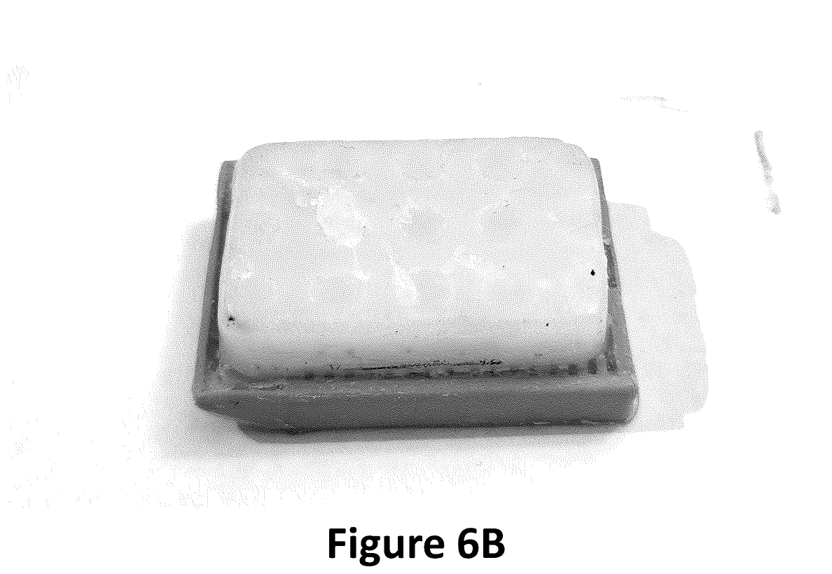

FIG. 6A, Cross-sectional view of a completely embedded microarray block (1000). The fully embedded microarray block (1000) consists of the cassette (6) and donor samples array (801-805) fully embedded in a final cuboid of solid matrix material (130).

FIG. 6B: Photograph of completely embedded microarray block

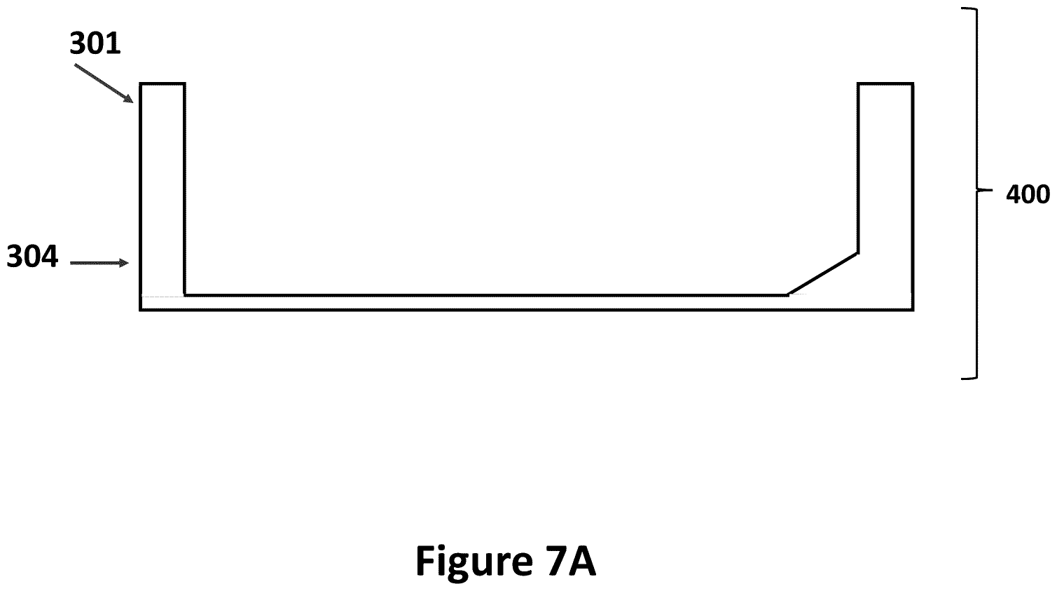

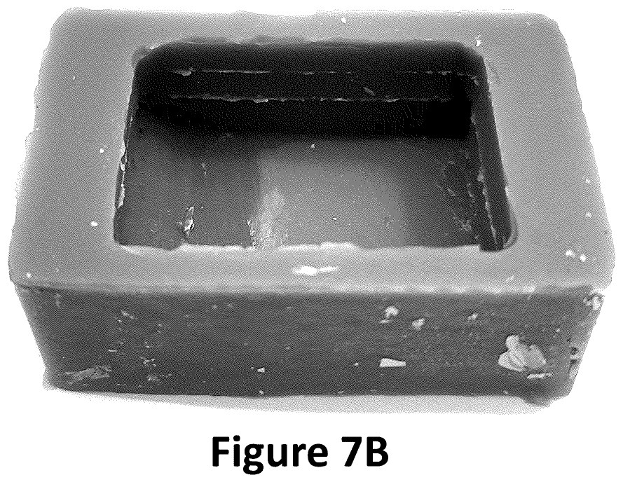

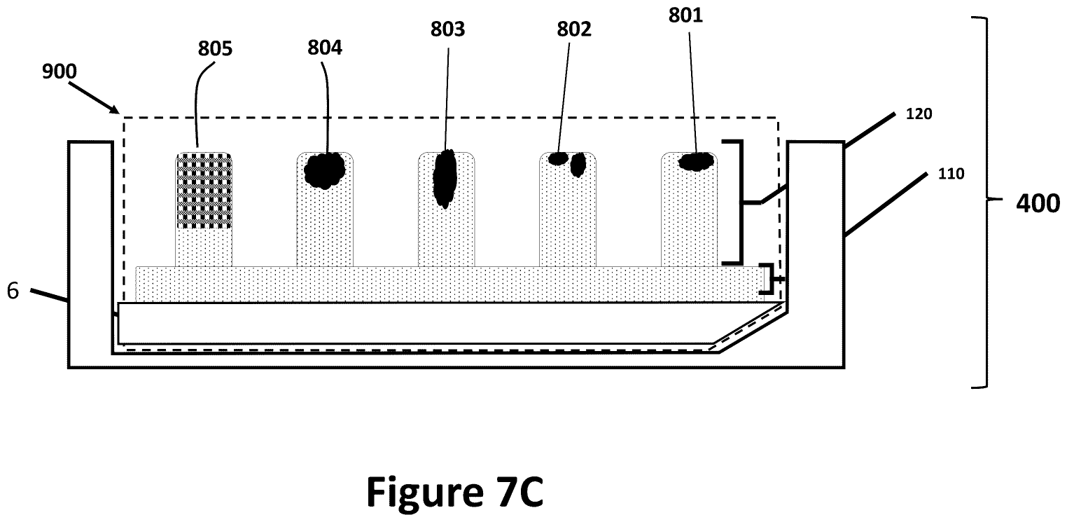

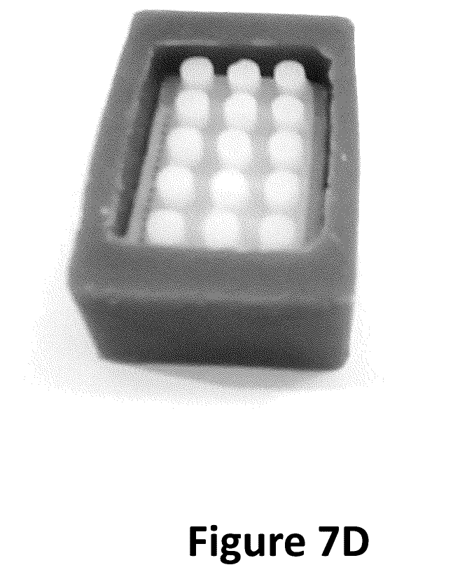

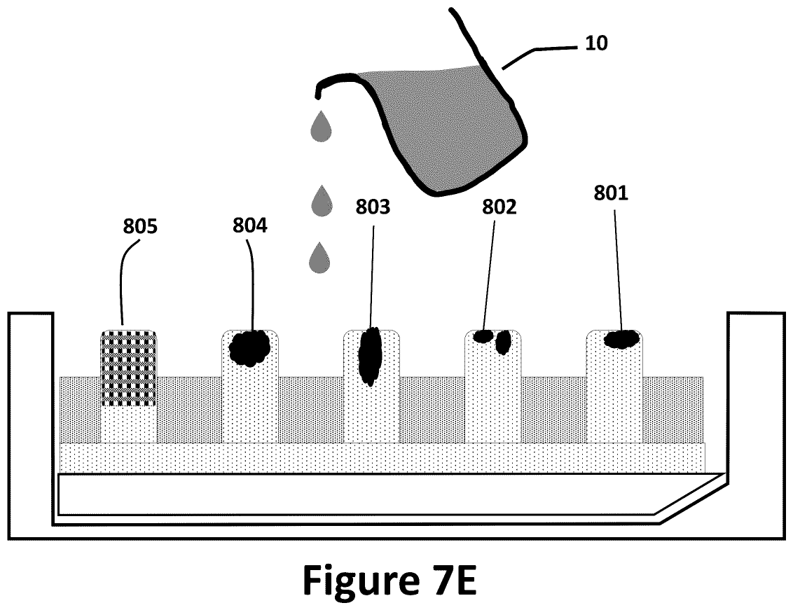

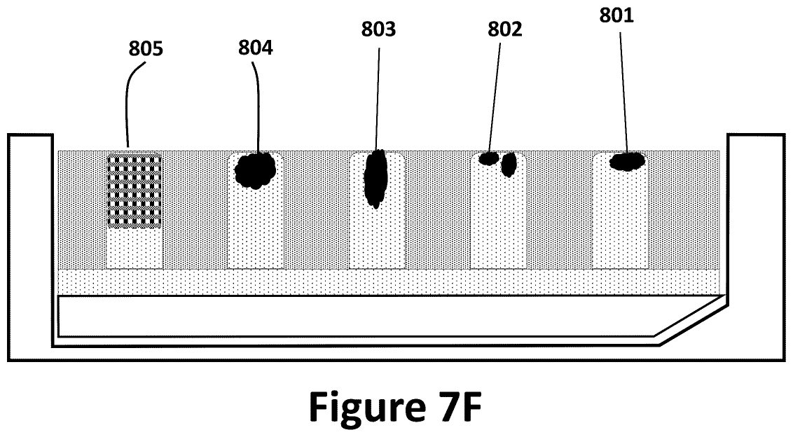

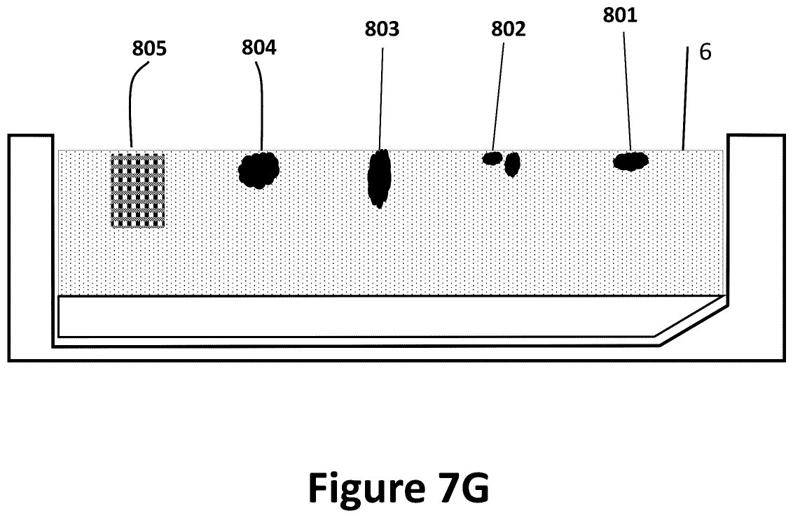

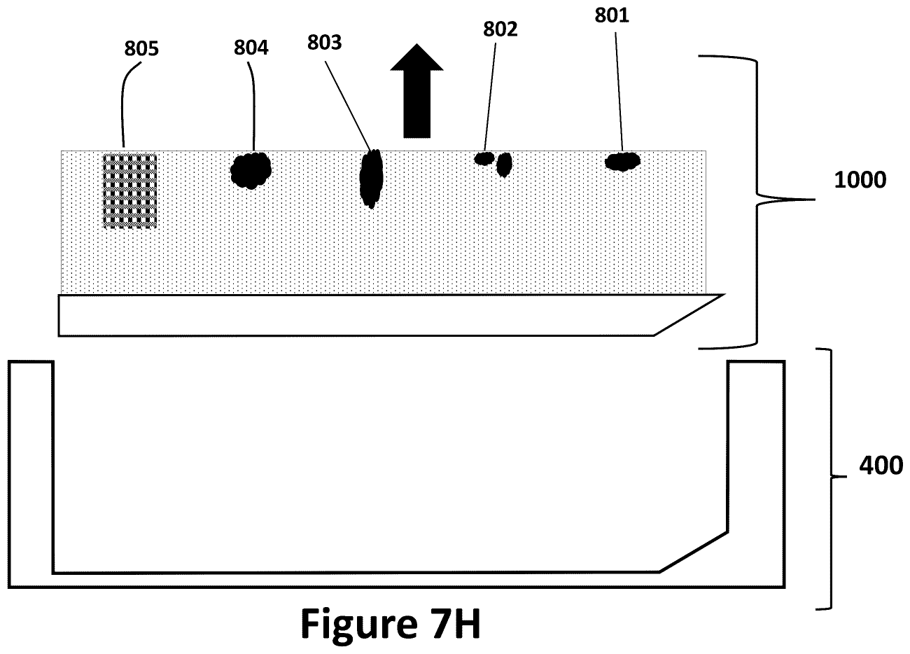

FIG. 7A, Cross-sectional view of the view of an example embodiment of a completion-mold (400). This completion mold is designed in a way that the partially embedded microarray block is inserted with its cylindrical extensions facing away from the mold (in contrast to the previous design shown in FIGS. (30) A-(G)). In this embodiment, the completion mold (400) has a frame (301) and base (304).

FIG. 7B: Photograph of a prototype of a completion mold designed to receive the partially embedded microarray block with its cylindrical extensions facing away from the completion mold.

FIG. 7C, Cross-sectional view of the view of an example embodiment of a completion-mold (400). This completion mold is designed in a way that the partially embedded microarray block (900) is inserted with its cylindrical extensions (120) facing away from the mold (in contrast to the previous design shown in FIGS. 5A-G). In this embodiment, the partially embedded microarray block (900) is being inserted in the completion mold (400) with its cylindrical extensions (120) facing away from the mold. The partially embedded microarray block (900) consists of the cassette (6), the solidified matrix material cuboid (110), and the cylindrical extensions (120) holding the donor samples array (801-805). Notice how in this example embodiment of the completion mold, the partially embedded microarray block is inserted before the molten matrix material is added to the completion mold (in contrast to the previous design shown in FIGS. 5A-G).

FIG. 7D: Photograph showing the partially embedded microarray block inserted in the completion mold.

FIG. 7E, Cross-sectional view of the view of an example embodiment of a completion-mold. In this figure, matrix material (10) is seen being added to the completion mold. The matrix material will serve to fill in the gaps in between the cylindrical extensions of the partially embedded microarray block that is holding the donor samples microarray (801-805).

FIG. 7F, Cross sectional view of the view of an example embodiment of a completion-mold. In this figure, matrix material has been fully added and is pending solidification. Notice how all the spaces between the cylindrical extensions of the partially embedded microarray block is now filled with matrix material. This will provide physical support to the donor samples microarray (801-805).

FIG. 7G, Cross sectional view of the view of an example embodiment of a completion-mold. In this figure, matrix material has been fully added and is pending solidification. Notice how all the spaces between the cylindrical extensions of the partially embedded microarray block is now filled with matrix material. After the matrix material solidification, the microarray holding the donor samples array (801-805) is now considered fully embedded.

FIG. 7H, Cross-sectional view of the view of an example embodiment of a completion-mold. In this embodiment, the fully embedded microarray block (1000) holding the donor samples array (801-805) is being removed from the completion mold (400).

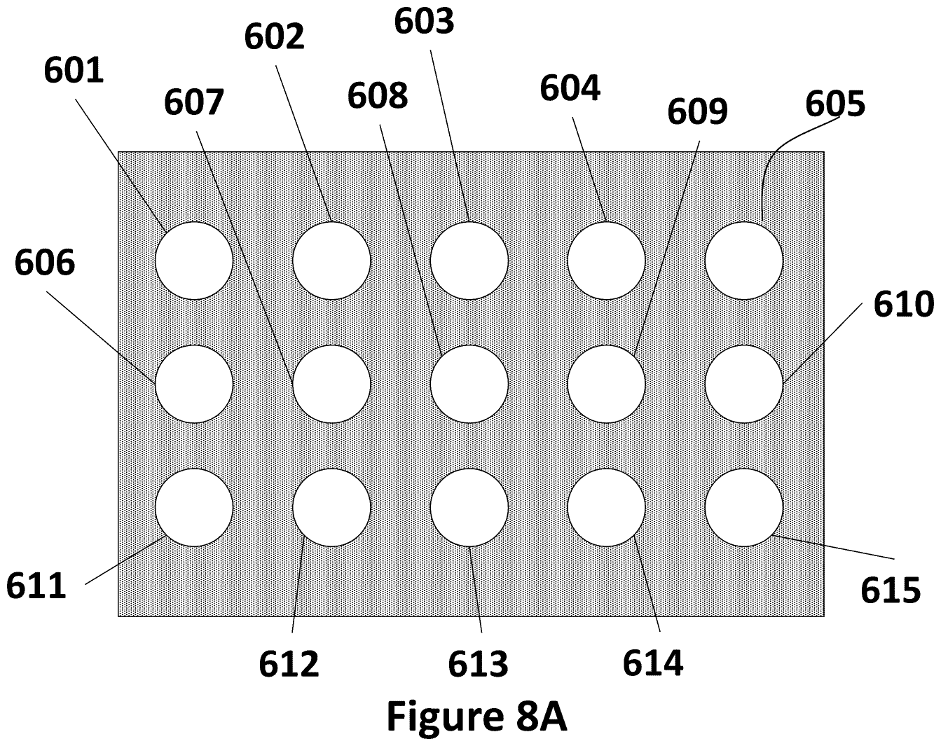

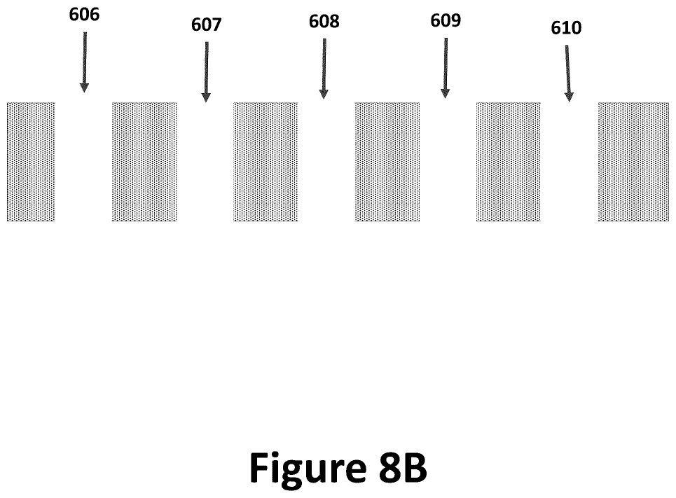

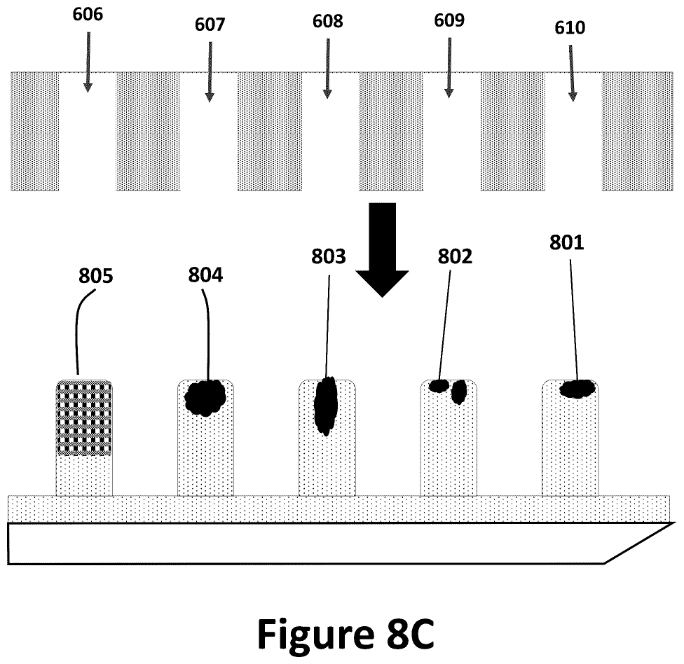

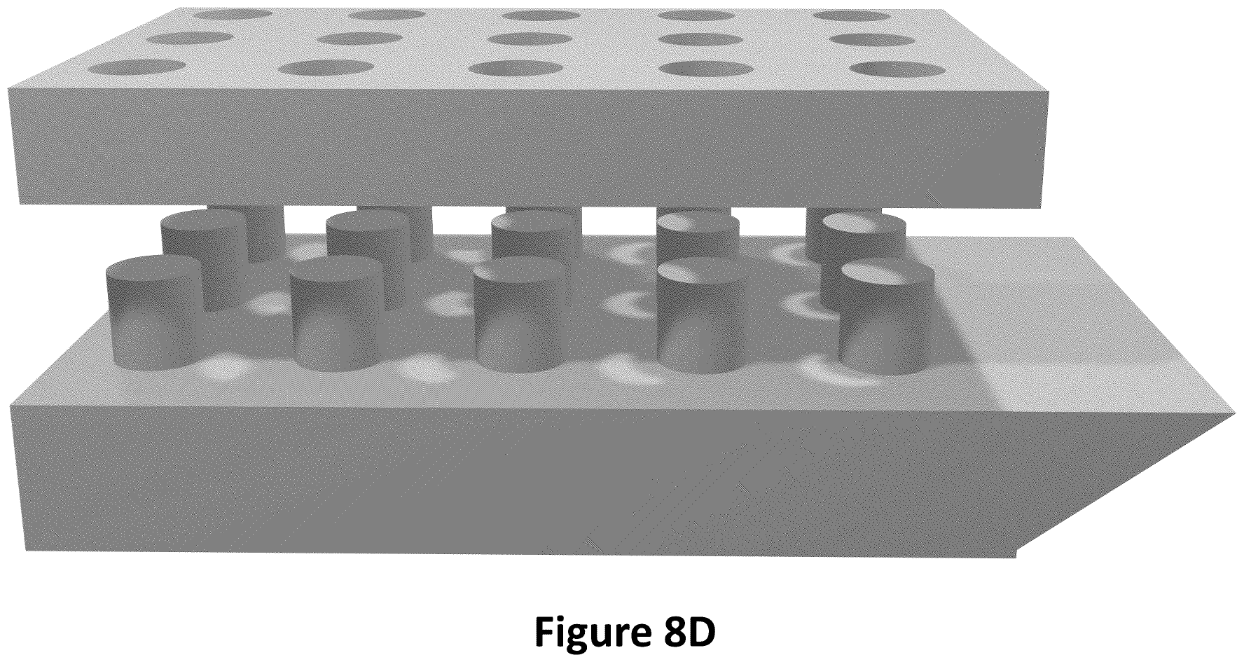

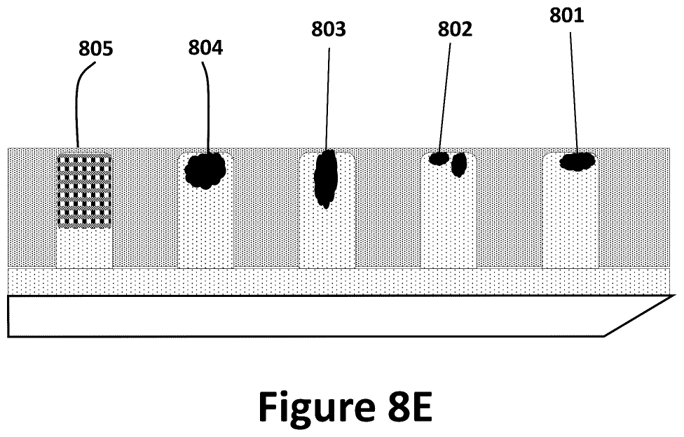

FIG. 8A Top view of an example embodiment of a fenestrated solid paraffin bar with multiple fenestrations (601-615) that will fit the cylindrical extensions of the partially-embedded-microarray block.

FIG. 8B: Cross-sectional view of an example embodiment of a fenestrated solid paraffin bar with multiple fenestrations (601-615) that will fit the cylindrical extensions of the partially-embedded-microarray block.

FIG. 8C: Cross-sectional view of an example embodiment of a fenestrated solid paraffin bar with multiple fenestrations (606-610) that is being inserted to fill the gaps in between the cylindrical extensions of the partially-embedded-microarray block holding the donor sample array (801-805).

FIG. 8D: Perspective view of an example embodiment of a fenestrated solid paraffin bar with multiple fenestrations that is being inserted to fill the gaps in between the cylindrical extensions of the partially-embedded-microarray block.

FIG. 8E: Cross-sectional view of an example embodiment of a completely embedded-microarray block holding the donor sample array (801-805).

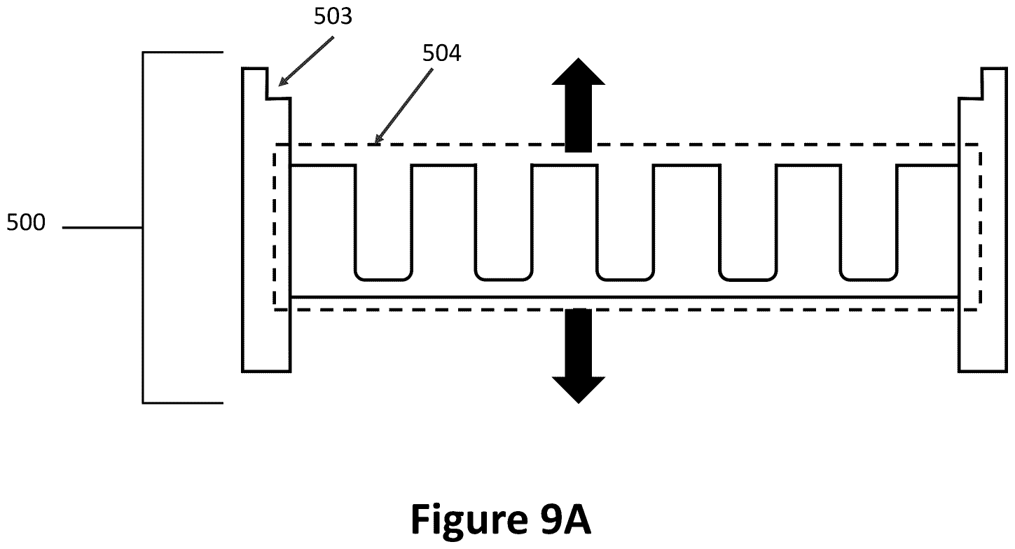

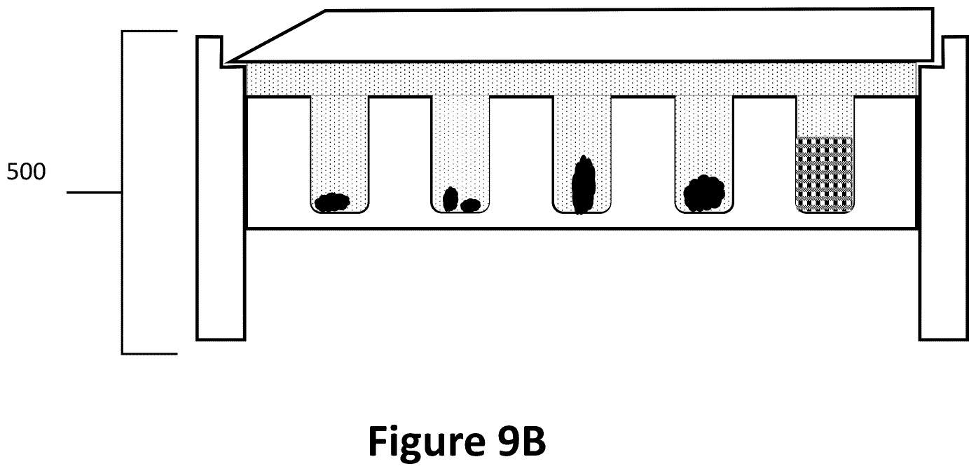

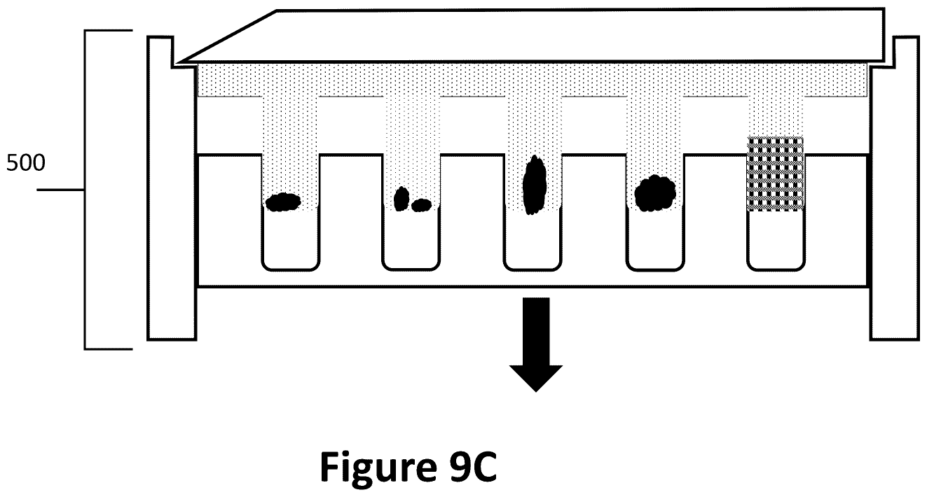

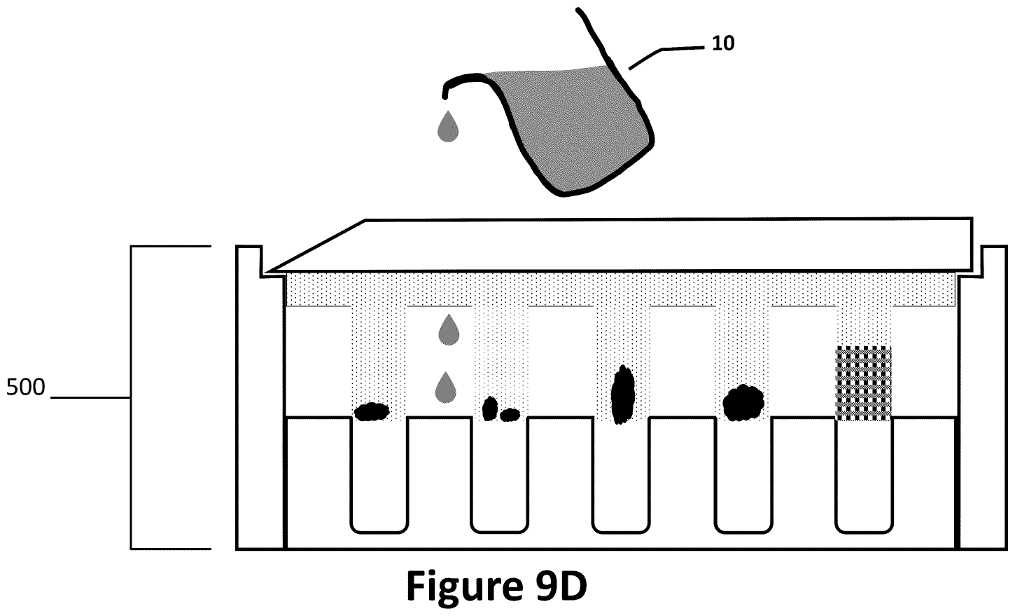

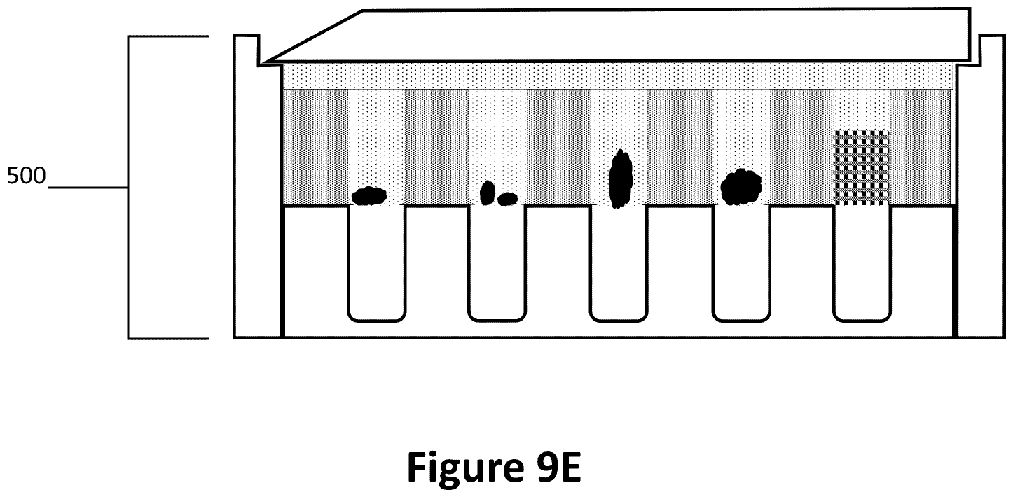

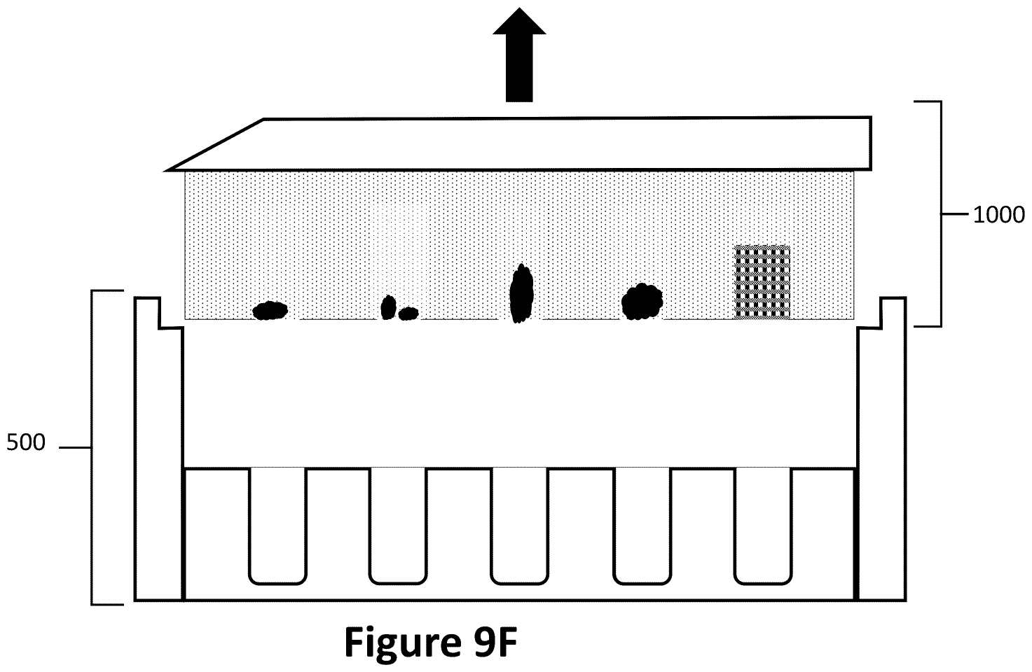

FIG. 9A displays a cross-sectional view of an exemplary design of a chambered-mold with movable body (500). In this example design, the mold body (504) is movable (indicated by the box with dashed outline) and contains a plurality of main chambers. The ability to move the main chambers allows for completion embedding using the same chambered mold rather than a separate completion mold.

FIG. 9B Displays a cross-sectional view of an exemplary design of a chambered-mold with movable parts (500) holding a partially-embedded-microarray block. When using this design, the partially-embedded-microarray block is constructed in a similar way to the method used with the chambered mold as shown in FIGS. (3A) through (3J).

FIG. 9C displays a cross-sectional view of an exemplary design of a chambered-mold with movable body (500) holding a partially-embedded-microarray block. In this embodiment, the movable body (containing the main chambers) is being moved away from the partially-embedded-microarray block.

FIG. 9D displays a cross-sectional view of an exemplary design of a chambered-mold with movable parts body (500) holding a partially-embedded-microarray block. After the body is moved away, molten matrix material (10) is added to fill in the gaps in between the cylindrical extensions of the partially-embedded-microarray block.

FIG. 9E displays a cross-sectional view of an exemplary design of a chambered-mold with movable body (500) holding a completely-embedded-microarray block. In this embodiment, the matrix material has been fully added to fill in the gaps in between the cylindrical extensions of the partially-embedded-microarray block.

FIG. 9F displays a cross-sectional view of an exemplary design of a chambered-mold with movable body (500) and a fully-embedded-microarray block (1000). In this embodiment, the fully embedded microarray block (1000) is being removed from the chambered-mold with movable body (500), after the matrix material has been solidified.

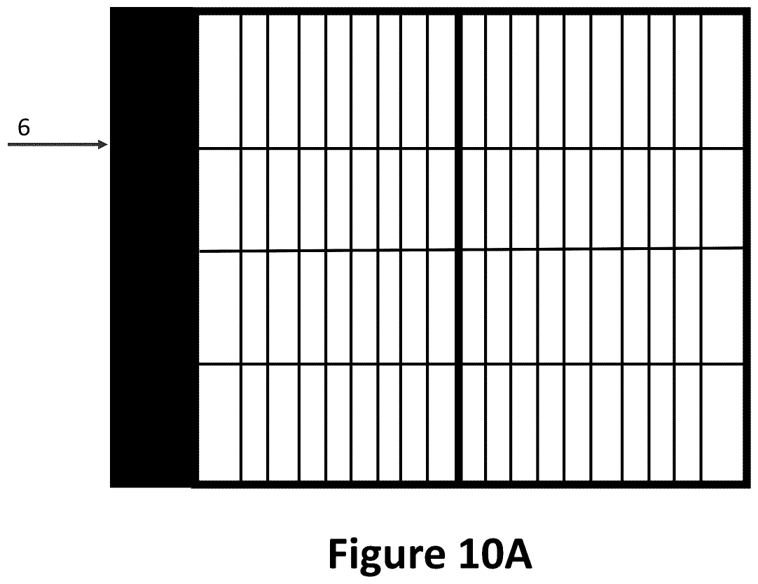

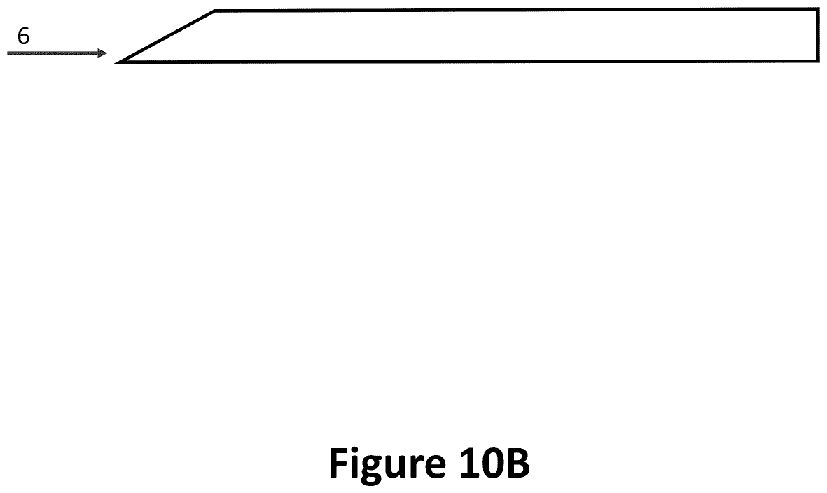

FIG. 10A: Top view of a widely used histologic cassette (6)

FIG. 10B: Side view of a widely used histologic cassette (6)

### DETAILED DESCRIPTION OF THE INVENTION

The definition of “sample” used here encompasses biologic samples obtained from humans or animal tissues. Tissues can be fresh, frozen, fixed, or embedded in any matrix material, such as paraffin.

The term “microarray” as used in this context describes the product obtained from arranging numerous separate samples (such as human tissues) into one block of matrix material (such as paraffin). Microarray construction is a widely used technique in the field of histopathology that allows for analysis of multiple tissue samples on a single glass slide, making it useful for applications such as biomarker discovery and disease diagnosis. This technology can be applied to a broad range of in situ assays, such as special staining, in situ hybridization, immunohistochemistry, and more. Tissues from humans and animals can all be used in tissue microarray construction, and the resulting slide can be used for microscopic analysis of intracellular proteins or nucleic acid.

The term “donor sample” refers to a part or a whole of a “parent sample” from a specific source (such as organ or patient), that is desired to be included in the tissue microarray (as one of multiple other samples from multiple sources). The donor sample is typically a part of a parent sample that is being transferred from the parent block to be combined with an array of other donor samples in a microarray block (each donor sample from a specific parent sample). If the parent sample is embedded in matrix material, transfer of the donor sample is typically done through core needles that can extract a cylindrical core of tissue from the parent sample. If the parent sample is not embedded in matrix material, part or whole of it can be directly placed in a main chamber of the chambered mold.

The term “matrix material” refer to a substance that forms the base or support structure for embedding other materials. Examples of matrix material; paraffin wax, agarose gel, synthetic wax, natural wax, optimal cutting temperature compound, resin, epoxy, or any other material that share similar characteristics. Matrix materials are typically liquid when applied, and it solidify thereafter.

The term “embedding” as used in this context describes the process of infusing a tissue with a matrix material (usually paraffin) that will solidify and offer support for sectioning.

The term “cassette” in this context refers to a tool that serves as a holder for supporting a block of solidified matrix material (and the tissue embedded in the matrix material, if any). After pouring molten matrix material (such as paraffin) into a mold, the cassette is inserted on top. The matrix material (such as paraffin) and the tissue embedded in it become firmly attached to the cassette as it solidifies. When sectioning a tissue block (comprising the matrix material, tissue, and cassette), a microtome is typically used with a holder designed for a cassette. The attachment of the embedded tissue to the cassette makes it easy to attach, detach, and section the tissue block using the microtome. The cassette is a suitable histologic cassette of any suitable type made from any suitable material such as rigid plastic. FIGS. 10A and 10B shows example of a widely used histologic cassette.

The term “main chamber” is defined as a hollow space in the chambered mold that is typically cylindrical. The main chamber is the site where at least one donor sample is inserted. The main chamber has two opposite ends where at least one is open.

The term “orientation chamber” is defined as at least one chamber in the chambered mold that has a specific location that serves to orientate the chambered mold in a certain orientation that is known by the user. The orientation chamber is used to orient the microarray block, and the sections cut from that block. Materials that are placed in the orientation chamber can be a known donor sample or can be any other material including non-biologic material such as ink, coloring material, cotton, or any other material without restriction. The orientation chamber can be designed in any location, size, depth, or shape as desired, without any restrictions. By using the orientation chamber, the user can easily keep track of the location of each core on the slide and link it to the corresponding sample in a known database. The orientation chamber is an optional component of the chambered mold.

The “reservoir” is defined as the space between the top end of the chambers, the bottom surface of the cassette, and the surrounding inner surfaces of the frame. The reservoir serves to hold the additional matrix material (in addition to the matrix material filling the chambers), which will provide additional physical support to the microarray block. This component is optional. Therefore, the chambered mold can be designed with no reservoir, where the bottom surface of the cassette sits directly on the top ends of the chambers, however this might result in a physically fragile tissue microarray block.

The term “recipient block’, as used herein, is intended to refer to a block of matrix material (whether with attached cassette or not) that serve to receive multiple donor samples (usually in the form of cores) from multiple parent samples to construct a microarray. The recipient block is used here only to discuss prior art in which the conventional methods of microarray construction, the recipient block is typically in a rectangular parallelepiped form and has multiple cylindrical holes for accommodating donor samples. It is made mainly from paraffin, and it can be commercially sold as disposable block or can be made from a specific mold. Our invention bypasses the step of making/using a recipient block for microarray construction. We are including it in our discussion as an example of prior art, and to provide an easy-to-understand comparison to our invention.

The term “partially-embedded-microarray block (PEMB)” refers to the tissue microarray block that results from using the chambered mold before the step of completion embedding. The partially-embedded-microarray-block consists of the cassette in addition to the matrix material holding the donor samples. The matrix material typically will be cuboid with multiple cylindrical extensions. The cylindrical extensions are the inverse to the main chambers of the chambered mold.

The term “completion embedding” refers to the step of adding matrix material to a partially-embedded-microarray block to fill the gaps In between its cylindrical extensions. This process can be done using a completion mold or a fenestrated solid paraffin bar.

A “completion mold” refers to a mold designed to accommodate the partially embedded microarray block (PEMB), initially created by the chambered mold. The PEMB is placed into the completion mold, where molten matrix material fills the voids within the partially embedded microarray block. Once the matrix material solidifies, the PEMB is fully embedded, allowing it to be extracted from the completion mold for its intended use. The completion mold can come in various designs.

The term “fenestrated solid paraffin bar” refers to a block of matrix material that is made to be complementary to the cylindrical extensions of the partially-embedded-microarray block. It serves to be an alternative to the use of a completion mold in the completion-embedding step.

The invention encompasses various embodiments wherein an apparatus and method are presented for constructing a microarray block.

The following embodiments of the invention provided below serve as illustrative examples, which may, in certain cases, have broader scope than the preceding embodiment or the overall invention. They are not intended to restrict the breadth of the foregoing embodiment or the invention itself. Optional additional features described in these embodiments are not mandatory. Any feature from the embodiments below can be combined with the preceding embodiment, either with or without other features from the embodiments below. All characteristics, steps, parameters, and features of any method, process, apparatus, device, or system described herein are not limited to any specific embodiments presented, but are equally applicable to the preceding embodiment of the invention and all other embodiments. Some instances may involve replacing broad terms and descriptors with more specific ones, not to confine the disclosure to those specific terms or descriptors, but rather for the sake of clarity and comprehension.

The apparatus for constructing biologic microarrays comprises a chambered mold that is used to generate a PEMB. This is then followed by a completion embedding step using a completion mold or a fenestrated solid paraffin bar.

The components of each mold can be either separate or attached. The chambered mold and the completion mold can be made of the same material, or each one can be made from different types of material.

Both the chambered mold and the completion mold are typically made from elastomers (Natural Rubber, Styrene-Butadiene Rubber (SBR), Polyurethane (PU), Neoprene (Polychloroprene), Nitrile Rubber (NBR), Silicone Rubber, Ethylene Propylene Diene Monomer (EPDM), Fluoroelastomers (FKM), Butyl Rubber (IIR), Chlorosulfonated Polyethylene (CSM) or any other types of synthetic rubbers).

FIGS. 1A, 1B, and 2 show an embodiment of a chambered mold.

### Basic Component of the Chambered-Mold:

The chambered mold is equipped with at least two chambers, often more, and the number of main chambers can vary. In our illustrated prototype (refer to FIGS. 1A, 1B, and 2), there are 15 chambers, but the chambered mold can be configured with any number of chambers. These main chambers typically take on a cylindrical form, with flexibility in dimensions and arrangement within the mold. Each main chamber possesses opposing first and second ends, where the first end features an opening for inserting at least one donor sample, while the second end is typically sealed.

The sizing of each main chamber is not constrained and can be tailored based on design preferences and the desired size and quantity of donor samples for arraying. For instance, the chambered mold depicted in FIGS. 1A, 1B, and 2 showcases main chambers with a diameter of 4.5 mm and a depth of 4 mm. Nevertheless, the chambered mold can be manufactured with main chambers of varying diameters.

The donor samples introduced into these main chambers consist of human or animal tissue, and these samples may either be previously embedded in matrix material (such as paraffin) or remain unembedded. The biological material can be fixed using fixatives like formalin, or it can be fresh or frozen.

Base: The base refers to the lower surface of the chambered mold that can be situated on a work surface. It may be affixed to or distinct from the main chambers and the frame. The dimensions of the base can be adjusted according to the designer's preference and the specific requirements for the size and quantity of donor samples intended for inclusion in the array.

### Optional Components of the Chambered-Mold:

Frame: The frame may be connected to or distinct from both the base and the main chambers. It links the main chambers to the cassette holder and functions to establish a reservoir that supports and contains the molten matrix material until it solidifies. The frame plays a role in preventing the leakage of molten matrix material from the main chambers and the reservoir until the material solidifies. The dimensions of the frame are adaptable, allowing customization based on the designer's preferences and the specific requirements for the size and quantity of donor samples intended for inclusion in the array.

Cassette-holder: This element functions as a holder for the cassette that connects to the microarray block. The cassette-holder may be integrated with or detached from the frame. While it is typically a feature of the chambered mold, its inclusion is discretionary. For instance, the chambered mold can be configured without a cassette holder. In such instances, the cassette can be affixed to the microarray block at a subsequent stage.

Orientation-chamber: The Orientation-chamber is defined as at least one chamber in the chambered-mold that has a specific location that serves to orientate the chambered mold in a certain orientation that is known by the user. The orientation chamber (as illustrated in FIG. 1A) is used to orient the Microarray block, and the sections cut from that block. Materials that are placed in the orientation chamber can be a donor sample or can be any other material including non-biologic material such as ink, coloring material, cotton, or any other material without restriction. The orientation chamber can be designed in any location, size, depth, or shape as desired, without any restrictions. By using the orientation chamber, the user can easily keep track of the location of each core on the slide and link it to the corresponding sample in a known database.

In a microarray, each core represents a small sample (donor sample) of tissue taken from a larger tissue specimen (parent sample). To accurately track which core is from which case, a unique identifier is assigned to each core and is associated with the corresponding patient case in a database. This identifier is usually printed on a map that accompanies the microarray slide, which indicates the position of each core on the slide and provides information about the corresponding case, such as patient ID, diagnosis, and clinical data. However, to efficiently use this map, it is important to number the donor samples in the array. This is where an optional orientation chamber can be included in the chambered mold. The orientation chamber is of a known location in the mold, for example, toward the left upper corner. It serves to orientate the microarray block in a certain way that is known by the user. The orientation chamber can be designed in any location, size, depth, or shape as desired, without any restrictions. For instance, the prototype that we designed (FIG. 1A) includes an orientation-chamber that is smaller in size than the rest of the chambers and is located in the area between main-chambers 1, 2, 6, and 7, rather than the regular arrangement of chambers. This orientation-chamber correlates to the left upper corner of the chambered mold, so the main-chamber to the left-upper side of the orientation-chamber is numbered as main-chamber #1, and the next main-chamber will be #2, and so on. By using the orientation-chamber, the user can easily keep track of the location of each donor sample on the slide and link it to the corresponding patient case in the database.

Reservoir: The “reservoir” is defined as the space between the top end of the main chambers, the bottom surface of the cassette, and the surrounding inner surfaces of the frame. The reservoir serves to hold the additional matrix material (in addition to the matrix material filling the chambers), which will provide additional physical support to the Microarray block. This component is optional. Therefore, the chambered mold can be designed with no reservoir, where the bottom surface of the cassette sits directly on the top ends of the chambers, however this might result in a physically fragile tissue Microarray block.

### Basic Components of the Completion-Mold:

Base: The base is the bottom bottom surface that can be placed on a work surface. The base can be attached or separate from the frame. The dimensions of the base can vary depending on the preference of the designer and the size and number of the donor samples needed to be included in the microarray.

Frame: The frame can be attached or separate from the base. The frame serves to support and hold the molten matrix material till the matrix material solidifies. The frame prevents leaking of the molten matrix material from the mold till the matrix material solidifies. The dimensions of the frame can vary depending on the preference of the designer and the size and number of the donor samples needed to be included in the array.

### Optional Components of the Completion-Mold:

Cassette-holder: This component serves to hold the cassette that attaches to the microarray block. The Cassette-holder can be attached or separate from the frame. The cassette-holder is typically part of the non-chambered-mold, but it is optional. For example, the completion mold can be designed without a cassette holder. In this case, the cassette can be added to the microarray block at a later stage.

To enhance understanding of the current invention, contemplate the subsequent example presented as an illustration, albeit not an exhaustive representation, of the scope of the present invention.

### Example Construction of Tissue Microarray Block Using the Chambered Mold (FIGS. 3A Through 4B)

Step 1: Parent samples needed to arrayed are identified.

Step 2: At least one donor sample is taken from a parent sample (FIG. 3A through 3B). This process can be using manual or automated tissue core needle or punches devices, forceps, manual extraction, or any other way. Other mechanisms of extracting donor samples from parent samples include, without restriction, removing the donor sample from the parent sample by a blade or any other tool, or by melting the matrix material holding the parent sample. If the donor samples that needed be added are in aqueous form, pipetting or direct pouring can be done.

Step 3: At least one donor sample is placed into a main chamber (FIG. 3C through 3D). Subsequent donor samples are placed as desired (FIG. 3E).

Step 4: After all the desired donor sample(s) are inserted in the chambered mold, liquid matrix material is added to the chambered mold to embed the donor samples (FIG. 3F). At this stage, a cassette can be used to provide additional support to the block (FIG. 3G through 3I). The chambered mold will function as a casting mold system that will hold the cassette, matrix material and the array of donor samples together.

Step 5: When the matrix material solidifies, the microarray block can be removed from the chambered mold (FIG. 3J). At this stage, the microarray block is considered partially embedded (FIGS. 4A through 4B). The partially embedded microarray block has cylindrical extensions holding the donor samples array. These multiple cylindrical extensions are the inverse to the main chambers of the chambered mold.

Step 6: Completion embedding step: This step serves to fill the gaps between the cylindrical extensions of the partially embedded microarray block in order to be used for sectioning and analysis. This step can be done using a completion mold (FIGS. 5A through 7H) or a fenestrated solid paraffin bar (FIG. 8A through 8E).

If using a completion mold (FIGS. 5A through 7H), the partially-embedded microarray block is inserted into the completion mold in addition to additional matrix material (which can be of similar or different type to the initial material used). The matrix material will fill in the gaps in between the cylindrical extensions of the partially-embedded microarray block. The matrix material can be added to the completion mold before or after the insertion of the partially embedded Microarray block depending on the design of the completion mold. After the additional matrix material is added and solidified, the microarray block is now fully embedded and can be removed from the completion mold.

Alternatively, fenestrated solid paraffin bar (FIG. 8A through 8E) can be used to fill the gaps in the partially embedded microarray block. The fenestrated solid paraffin bar can be made using a mold that is inverse to the chambered mold.

Step 8: The Microarray block can be sectioned for the desired analysis.

The chambered mold and the completion mold can be designed in one mold instead of two separate molds. FIG. 9A through 9F show an example embodiment of a mold with movable body that can serve to do the completion embedding in the same mold that the array is constructed.

To the best of our knowledge, our invention represents a groundbreaking solution, addressing numerous challenges present in prior methods and designs for microarray construction. The background of our team, including extensive TMA-based research, provided valuable insights into the limitations of conventional methods and empowered us to create a solution.

Our invention, characterized by ease of use, affordability, consistent results, and resolution of multiple challenges inherent in conventional methods, also delivers superior outcomes in a shorter timeframe.

Key advantages of our system over conventional methods include:

Uniform Tissue Level: The chambered mold allows the addition of matrix material after arraying donor samples, ensuring all tissues in the microarray are at the same level, reducing tissue loss.

Ease of Donor Sample Insertion: Inserting donor samples is simplified as it occurs before matrix material pouring, avoiding complications associated with systems requiring insertion into a solid matrix.

Unified Component Integration: The system enables the addition of tissues, histologic cassette, and matrix material simultaneously, preserving alignment and preventing distortion without the need for a separate base mold.

Elimination of Melting Requirements: Unlike prior art, our system doesn't necessitate oven baking or melting of matrix material or embedded tissues, avoiding potential heat-induced damage.

Reusability and Ease of Cleaning: Our system is designed for repeated use, easy maintenance, and consistency in results, enhancing the efficiency and accuracy of tissue microarray construction.

Versatility in Biologic Sample Types: Our mold accommodates various biologic samples, such as fresh tissue, frozen tissue, formalin-fixed paraffin-embedded tissue, cell culture, nucleic acid, and proteins.

Flexible Donor Tissue Size: The system allows for varied donor tissue sizes, favoring smaller diameters, providing more support with aqueous matrix material and simplifying the insertion process.

Suitability for Limited Quantity Tissues: With minimal tissue loss, our invention is suitable for embedding small tissue biopsies, overcoming limitations of conventional methods requiring larger quantities.

No Requirement for Recipient Block: Our invention doesn't rely on a recipient block, preventing cracking and distortion during tissue insertion, thereby preserving the microarray block's structure.

No Disposable Components: Unlike some conventional methods, our invention requires no disposable parts, contributing to cost-effectiveness and environmental sustainability.

No Need for Moving Donor Samples Between Molds: The system avoids the need to move donor samples between molds, preventing unsupported tissue arrays in aqueous matrix material and maintaining orientation and predetermined sequences.

Avoidance of Hot Surface Flattening: Unlike conventional methods, our invention eliminates the step of using a hot flat surface, reducing the risk of distortion and loss of predetermined arrangement.

In summary, our invention stands out for its time efficiency, enabling the arraying of 15 donor samples in less than five minutes, showcasing a significant reduction compared to alternative methods.

1. A mold for the construction of microarray blocks, comprising at least two main chambers, each main chamber configured to receive at least one donor sample, the main chamber having two opposite ends, wherein one end is open and the other is closed; wherein the mold is typically constructed from elastomers, including but not limited to natural rubber, styrene-butadiene rubber, polyurethane, neoprene/polychloroprene, nitrile rubber, silicone rubber, ethylene propylene diene monomer, fluoroelastomers, butyl rubber, chlorosulfonated polyethylene, or any other elastomeric material or any combination thereof; wherein the main chambers of the mold typically have a cylindrical shape designed to receive at least one donor sample; and wherein the main chambers of the mold can be configured in different number, size, depth, and arrangement, providing flexibility to accommodate different sizes and numbers of donor samples.

2. A method for constructing a microarray block using the mold of claim 1, comprising the steps of: a. Identifying at least one parent sample; b. Extracting at least one donor sample from a parent sample; c. Placing the donor sample(s) into the main chamber(s) of the mold; d. Adding liquid matrix material to the mold; e. Allowing the matrix material to solidify; f. removing the microarray block from the chambered mold.

3. A mold for the construction of microarray blocks comprising at least two main chambers, each main chamber configured to receive at least one donor sample; wherein the mold is typically constructed from elastomers, including but not limited to natural rubber, styrene-butadiene rubber, polyurethane, neoprene/polychloroprene, nitrile rubber, silicone rubber, ethylene propylene diene monomer, fluoroelastomers, butyl rubber, chlorosulfonated polyethylene, or any other elastomeric material or any combination thereof; and wherein the main chambers of the mold can be configured in different numbers, sizes, depths, and arrangements, providing flexibility to accommodate different sizes and numbers of donor samples.
